(19) United States
(12) Patent Application Publication
(10) Pub. No.: US 2005/0095508 A1
(43) Pub. Date: May 5, 2005

(54) Lithium-iron disulfide primary battery

(75) Inventor: Kenta Yamamoto, Fukushima (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/974,763

(22) Filed: Oct. 28, 2004

(30) Foreign Application Priority Data
Nov. 5, 2003 (JP) 2003-376250

(51) Int. Cl. H01M 6/16; H01M 4/58

(52) U.S. Cl. 429/339; 429/341; 429/231.95; 429/221; 429/326; 429/329

(57) ABSTRACT

There is provided a lithium-iron disulfide primary battery capable of suppressing the elevation of the open circuit voltage during the storage of battery. The lithium-iron disulfide primary battery has a positive electrode, which has iron disulfide as a cathode active material, including a cathode composition layer formed on a cathode current collector, a negative electrode including lithium as an anode active material, and an electrolytic solution including an electrolyte dissolved in an organic solvent. The organic solvent includes at least an alkylamide solvent. By this construction of the battery, the elevation of the open circuit voltage of the lithium-iron disulfide primary battery during the storage may be suppressed. Therefore, even after being stored for a long term, the lithium-iron disulfide primary battery can maintain compatibility with 1.5-V class primary batteries and the like.

### CROSS REFERENCE TO RELATED APPLICATIONS

The present document is based on Japanese Priority Document JP2003-376250, filed in the Japanese Patent Office on Nov. 5 2003, the entire contents of which being incorporated herein by reference.

### BACKGROUND OF THE INVENTION

1. Field of the Invention

The present invention relates to a lithium-iron disulfide primary battery which includes a positive electrode that uses iron disulfide as a cathode active material, a negative electrode that uses lithium as an anode active material, and an electrolytic solution.

2. Description of Related Art

1.5-V class primary batteries currently commercially available include a manganese battery, an alkaline manganese battery, a silver oxide battery, an air battery, and a nickel-zinc battery, each using an aqueous solution as an electrolytic solution, and a lithium-iron disulfide primary battery using an organic solvent in an electrolytic solution.

Among these batteries, the lithium-iron disulfide primary battery is a battery that has recently especially attracted attention. The lithium-iron disulfide primary battery is constituted by materials having high theoretical capacity. Specifically, iron disulfide used as a cathode active material and lithium used as an anode active material have theoretical capacities of about 894 mAh/g and about 3,863 mAh/g, respectively. In addition, the lithium-iron disulfide primary battery has not only high battery capacity but also excellent battery characteristics including load characteristics and low-temperature characteristics, and thus is an extremely excellent battery distinguished from other 1.5-V class primary batteries.

By the way, the lithium-iron disulfide primary battery has an initial open circuit voltage (OCV) of about 1.7 to 1.8 V and an average discharge voltage of about 1.3 to 1.6 V. Therefore, the lithium-iron disulfide primary battery is compatible with other 1.5-V class primary batteries, that is, the lithium-iron disulfide primary battery can be used in devices in which other 1.5-V class primary batteries can be used.

However, the lithium-iron disulfide primary battery has a disadvantage in that the open circuit voltage of the battery is gradually increased during the storage for a long term and often exceeds 2 V. When the lithium-iron disulfide primary battery having an increased open circuit voltage is used in a device, a problem occurs in that a protective circuit in the device inhibits the appliance from being switched on, namely, the lithium-iron disulfide primary battery is not compatible with other 1.5-V class primary batteries.

For solving the problem, a battery which can suppress the elevation of the open circuit voltage during the storage of battery for a long term by virtue of the electrolytic solution solvent containing a potassium salt, such as potassium iodide or potassium trifluoromethanesulfonate, has been proposed (see Patent document 1). These additives are considered to have a certain effect on the cathode active material. [Patent document 1] Japanese Patent Application Publication (kohyo) No. Hei 11-507761

### SUMMARY OF THE INVENTION

However, in the above-mentioned battery, the electrolytic solution has a very poor solvent power for a potassium salt, and therefore only an extremely slight amount (0.001 to 0.05 mol/l) of a potassium salt can be added into the electrolytic solution. For this reason, the addition of the potassium salt cannot offer a satisfactory effect of suppressing the elevation of the open circuit voltage.

Accordingly, it is desirable to provide a lithium-iron disulfide primary battery which can suppress an elevation of an open circuit voltage during the storage of battery.

According to an embodiment of the present invention, there is provided a lithium-iron disulfide primary battery including:
a positive electrode including iron disulfide as a cathode active material;
a negative electrode including lithium as an anode active material; and
an electrolytic solution including an electrolyte dissolved in an organic solvent,
wherein the organic solvent includes an alkylamide solvent represented by the following formula (1): 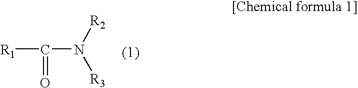
   wherein each of R₁ to R₃ represents a hydrogen group or a linear alkyl group.

In the present embodiment, the alkylamide solvent typically includes at least one solvent selected from a group including N,N-dimethylformamide (DMF), N,N-dimethylacetamide (DMA), and N,N-diethylformamide (DEF). It is preferred that the content of the alkylamide solvent in the organic solvent is 5 to 100% by volume.

In another embodiment of the present invention, the organic solvent typically includes the alkylamide solvent and a chain ether solvent. The chain ether solvent is typically 1,2-dimethoxyethane (DME). It is preferred that the content of the chain ether solvent in the organic solvent is 95% by volume or less.

In another embodiment of the present invention, the organic solvent typically includes the alkylamide solvent and a cyclic ether solvent. The cyclic ether solvent typically includes at least one solvent selected from a group including 1,3-dioxolane (DOL), 4-methyl-1,3-dioxolane (4MeDOL), tetrahydrofuran (THF), and 2-methyltetrahydrofuran (2MeTHF). It is preferred that the content of the cyclic ether solvent in the organic solvent is 95% by volume or less.

In another embodiment of the present invention, the organic solvent typically includes the alkylamide solvent and a chain carboxylic acid ester solvent. The chain carboxylic acid ester solvent is typically methyl propionate (MP). It is preferred that the content of the chain carboxylic acid ester solvent in the organic solvent is 95% by volume or less.

In another embodiment of the present invention, the organic solvent typically includes the alkylamide solvent and a chain carbonic acid ester solvent. The chain carbonic acid ester solvent typically includes at least one solvent selected from a group including ethyl methyl carbonate (EMC) and diethyl carbonate (DEC). It is preferred that the content of the chain carbonic acid ester solvent in the organic solvent is 95% by volume or less.

In another embodiment of the present invention, the organic solvent typically includes the alkylamide solvent and a mixed solvent of at least two solvents selected from a group including a chain ether solvent, a cyclic ether solvent, a chain carboxylic acid ester solvent, and a chain carbonic acid ester solvent. It is preferred that the content of the mixed solvent in the organic solvent is 95% by volume or less.

In another embodiment of the present invention, a potassium salt is added to the electrolytic solution. The potassium salt typically includes at least one member selected from a group including potassium fluoride (KF), potassium chloride (KCl), potassium bromide (KBr), potassium iodide (KI), and potassium trifluoromethanesulfonate (KCF₃SO₃).

In another embodiment of the present invention, it is preferred that the potassium salt concentration relative to the organic solvent is 0.05 to 0.5 mol/l. It is more preferred that the potassium salt concentration relative to the organic solvent is 0.05 to 0.3 mol/l. It is preferred that the potassium salt concentration relative to the alkylamide solvent is 1.0 mol/l or less. It is more preferred that the potassium salt concentration relative to the alkylamide solvent is 0.6 mol/l or less.

In another embodiment of the present invention, the lithium-iron disulfide primary battery includes a positive electrode including a cathode active material comprised of iron disulfide, a negative electrode including an anode active material having lithium, and an electrolytic solution including an electrolyte dissolved in an organic solvent, wherein the organic solvent includes an alkylamide solvent, and therefore the elevation of the open circuit voltage of the lithium-iron disulfide primary battery during the storage can be suppressed.

As mentioned above, according to the embodiment of the present invention, the elevation of the open circuit voltage of the lithium-iron disulfide primary battery during the storage can be suppressed, thus realizing a high-quality lithium-iron disulfide primary battery.

According to the embodiment of the present invention, a potassium salt is added to the organic solvent, and therefore the elevation of the open circuit voltage of the lithium-iron disulfide primary battery during the storage can be suppressed, thus realizing a higher-quality lithium-iron disulfide primary battery.

According to the embodiment of the present invention, not only the lowering of the electrostatic capacity but also the elevation of the open circuit voltage of the battery during the storage can be suppressed, thus realizing a higher-quality lithium-iron disulfide primary battery.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a sectional view showing an example of a structure of a lithium-iron disulfide primary battery according to the embodiment of the present invention;

FIG. 2 is a graph indicating a discharge capacity of the lithium-iron disulfide primary battery in Examples 1 to 13;

FIG. 3 is a graph indicating the discharge capacity of the lithium-iron disulfide primary battery in Examples 14 to 26;

FIG. 4 is a graph indicating the discharge capacity of the lithium-iron disulfide primary battery in Examples 27 to 39;

FIG. 5 is a graph indicating the discharge capacity of the lithium-iron disulfide primary battery in Examples 40 to 52;

FIG. 6 is a graph illustrating a change of an open circuit voltage of the lithium-iron disulfide primary battery in Examples 1 to 13 during the storage;

FIG. 7 is a graph illustrating the change of the open circuit voltage of the lithium-iron disulfide primary battery in Examples 14 to 26 during the storage;

FIG. 8 is a graph illustrating the change of the open circuit voltage of the lithium-iron disulfide primary battery in Examples 27 to 39 during the storage;

FIG. 9 is a graph illustrating the change of the open circuit voltage of the lithium-iron disulfide primary battery in Examples 40 to 52 during the storage;

FIG. 10 is a graph indicating an open circuit voltage value of the lithium-iron disulfide primary battery in Examples 1 to 13 after the storage;

FIG. 11 is a graph indicating the open circuit voltage value of the lithium-iron disulfide primary battery in Examples 14 to 26 after the storage;

FIG. 12 is a graph indicating the open circuit voltage value of the lithium-iron disulfide primary battery in Examples 27 to 39 after the storage;

FIG. 13 is a graph indicating the open circuit voltage value of the lithium-iron disulfide primary battery in Examples 40 to 52 after the storage;

FIG. 14 is a graph indicating the discharge capacity of the lithium-iron disulfide primary battery in Examples 53 to 78;

FIG. 15 is a graph indicating the open circuit voltage value of the lithium-iron disulfide primary battery in Examples 53 to 78 after the storage;

FIG. 16 is a graph indicating the discharge capacity of the lithium-iron disulfide primary battery in Examples 79 to 92;

FIG. 17 is a graph illustrating the change of the open circuit voltage of the lithium-iron disulfide primary battery in Examples 79 to 92 during the storage;

FIG. 18 is a graph indicating the open circuit voltage value of the lithium-iron disulfide primary battery in Examples 79 to 92 after the storage;

FIG. 19 is a graph indicating the discharge capacity of the lithium-iron disulfide primary battery in Examples 93 to 106;

FIG. 20 is a graph illustrating the change of the open circuit voltage of the lithium-iron disulfide primary battery in Examples 93 to 106 during the storage;

FIG. 21 is a graph indicating the open circuit voltage value of the lithium-iron disulfide primary battery in Examples 93 to 106 after the storage.

### DESCRIPTION OF THE PREFERRED EMBODIMENTS

Hereinbelow, one embodiment of the present invention will be described with reference to the drawings. In all the drawings used for the following embodiments, like parts or portions are indicated by like reference numerals.

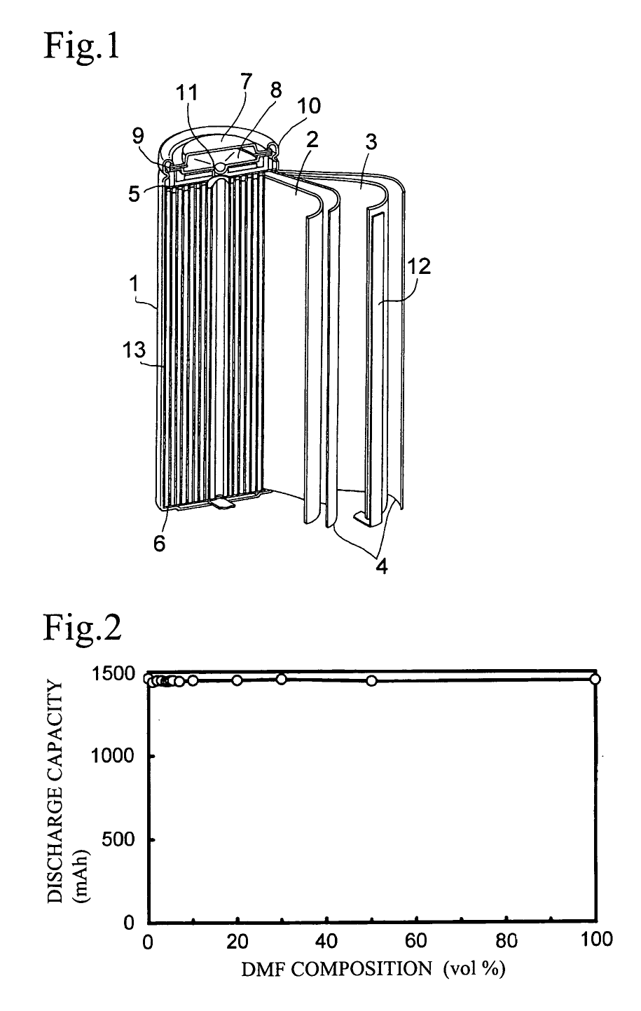

FIG. 1 shows one example of the construction of a lithium-iron disulfide primary battery according to one embodiment of the present invention. This lithium-iron disulfide primary battery is of a so-called cylindrical type, and has a spirally wound electrode assembly 13 in a battery casing 1 which is substantially hollow and cylindrical. The spirally wound electrode assembly 13 includes a strip positive electrode 2 having a cathode active material, a strip negative electrode 3 having an anode active material, and a separator 4 having ion permeability wherein the positive electrode 2, the negative electrode 3, and the separator 4 disposed between the positive and negative electrodes are spirally wound together many times.

The battery casing 1 includes, for example, a nickel-plated iron (Fe), and has one end closed and another end opened. A pair of insulating plates 5, 6 are contained in the battery casing 1 vertically relative to the circumferential surface of the casing so that the spirally wound electrode assembly 13 is disposed between the insulating plates.

To the opened end of the battery casing 1 are fitted a battery cover 7, and a safety valve 8 and a positive temperature coefficient element (PTC element) 9, which are provided on the inside of the battery cover 7, by crimping them through a sealing gasket 10 to seal the battery casing 1. The battery cover 7 includes, for example, the same material as that for the battery casing 1. The safety valve 8 is electrically connected to the battery cover 7 through the positive temperature coefficient element 9, and has so-called a current cut-out mechanism such that it cuts the electrical connection between the battery cover 7 and the spirally wound electrode assembly 13 when the battery suffers internal short-circuiting or is exposed to heat from an external heat source to cause the internal pressure of the battery to increase to a predetermined value or more. The positive temperature coefficient element 9 increases the resistance to restrict the current when the temperature rises, preventing the occurrence of accidental temperature elevation due to a large current, and includes, for example, barium titanate semiconductor ceramic. The sealing gasket 10 includes, for example, an insulating material, and had a surface coated with asphalt.

To the positive electrode 2 of the spirally wound electrode assembly 13 is connected a positive electrode lead 11 comprised of aluminum (Al) or the like, and to the negative electrode 3 is connected a negative electrode lead 12 comprised of nickel or the like. The positive electrode lead 11 is welded to the safety valve 8 and thus electrically connected to the battery cover 7. The negative electrode lead 12 is welded and electrically connected to the battery casing 1.

The separator 4 disposed between the positive electrode 2 and the negative electrode 3 is impregnated with, for example, a non-aqueous electrolytic solution as a non-aqueous electrolyte. The separator 4 is disposed between the positive electrode 2 and the negative electrode 3, and hence the separator prevents the positive and negative electrodes from being physically brought into contact with each other, and further keeps anon-aqueous electrolytic solution in its pores, that is, the separator 4 absorbs a non-aqueous electrolytic solution to allow lithium ions to pass therethrough during the discharge.

<Positive Electrode 2>

The positive electrode 2 includes a cathode current collector having a strip form, and cathode composition layers formed on both surfaces of the cathode current collector. The cathode current collector includes, for example, a metal foil, such as an aluminum foil, a nickel foil, or a stainless steel foil.

The cathode composition layer includes iron disulfide as a cathode active material, a potassium halide as an additive, an electrical conductor, and a binder. As iron disulfide constituting the cathode active material, one obtained by grinding pyrite present mainly in natural world may be used, and iron disulfide obtained by chemical synthesis, for example, calcining ferrous chloride (FeCl₂) in hydrogen sulfide (H₂S) can be used.

With respect to the electrical conductor, there is no particular limitation as long as it can impart electrical conductivity to the cathode active material when an appropriate amount of it is mixed into the cathode active material, and examples include carbon powder, such as graphite and carbon black. As the binder, a known binder can be used, and examples include fluororesins, such as polyvinyl fluoride (PVF), polyvinylidenefluoride (PVDF), and polytetrafluoroethylene.

<Negative Electrode 3>

The negative electrode 3 includes a strip metal foil. Examples of materials for the metal foil as an anode active material include metallic lithium and lithium alloys including lithium and an alloying element, such as aluminum.

<Electrolytic Solution>

As the electrolytic solution, one obtained by dissolving an electrolyte and a potassium salt in an organic solvent may be used. The organic solvent includes at least an alkylamide solvent represented by the following formula (1): 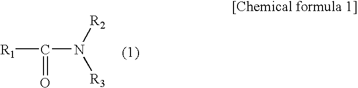
wherein each of R₁ to R₃ represents a hydrogen group or a linear alkyl group.

The organic solvent is, for example, a mixed solvent of an alkylamide solvent and at least one solvent selected from a group including a chain ether solvent, a cyclic ether solvent, a chain carboxylic acid ester solvent, and a chain carbonic acid ester solvent. Specifically, the alkylamide solvent is a mixed solvent of an alkylamide solvent and a chain ether solvent, a cyclic ether solvent, a chain carboxylic acid ester solvent, or a chain carbonic acid ester solvent, or a mixed solvent of an alkylamide solvent and at least two solvents selected from a group including a chain ether solvent, a cyclic ether solvent, a chain carboxylic acid ester solvent, and a chain carbonic acid ester solvent.

The alkylamide solvent includes, for example, at least one solvent selected from a group including N,N-dimethylformamide (DMF), N,N-dimethylacetamide (DMA), and N,N-diethylformamide (DEF).

The chain ether solvent is, for example, 1,2-dimethoxyethane (DME). The cyclic ether solvent includes, for example, at least one solvent selected from a group including 1,3-dioxolane (DOL), 4-methyl-1,3-dioxolane (4MeDOL), tetrahydrofuran (THF), and 2-methyltetrahydrofuran (2MeTHF). The chain carboxylic acid ester solvent is, for example, methyl propionate (MP). The chain carbonic acid ester solvent includes, for example, at least one solvent selected from a group including ethyl methyl carbonate (EMC) and diethyl carbonate (DEC).

As the electrolyte, a lithium salt is used. Examples of lithium salts include lithiumperchlorate (LiClO₄), lithium hexafluorophosphate (LiPF₆), lithium tetrafluoroborate (LiBF₄), lithium trifluoromethanesulfonate (LiCF₃SO₃), and lithium iodide (LiI).

The potassium salt includes, for example, at least one salt selected from a group including potassium fluoride (KF), potassium chloride (KCl), potassium bromide (KBr), potassium iodide (KI), and potassium trifluoromethanesulfonate (KCF₃SO₃). Specifically, the potassium salt includes potassium fluoride (KF), potassium chloride (KCl), potassium bromide (KBr), potassium iodide (KI), or potassium trifluoromethanesulfonate (KCF₃SO₃), or at least two salts selected from a group including potassium fluoride (KF), potassium chloride (KCl), potassium bromide (KBr), potassium iodide (KI), and potassium trifluoromethanesulfonate (KCF₃SO₃).

The potassium salt concentration relative to the organic solvent is preferably in the range of 0.05 to 0.5 mol/l, more preferably 0.05 to 0.3 mol/l. When the concentration is less than 0.05 mol/l, the effect of suppressing the elevation of the open circuit voltage is unsatisfactory.

In addition, the potassium salt concentration relative to the alkylamide solvent contained in the organic solvent is preferably in the range of 1.0 mol/l or less, more preferably 0.6 mol/l or less. When the concentration is more than 1.0 mol/l, the discharge capacity tends to be lowered.

<Separator>

As a separator, a microporous film comprised of polyolefin, such as polypropylene or polyethylene, or the like can be used.

Next, a method for producing the lithium-iron disulfide primary battery according to one embodiment of the present invention will be described.

First, for example, a cathode active material, a binder, and an electrical conductor are mixed with one another to prepare a cathode composition, and the cathode composition prepared is dispersed in a solvent, such as N-methyl-2-pyrrolidone, to prepare a pasty cathode composition slurry. The cathode composition slurry is applied to a cathode current collector and dried, followed by compression molding by means of a roller press or the like, to form a cathode composition layer, thus producing a positive electrode 2. If necessary, an additive may be added to the cathode composition.

Then, the thus obtained strip positive electrode 2, a negative electrode 3 having a strip form, and a separator 4 having a strip form are stacked on one another in the order of, for example, the positive electrode 2, the separator 4, the negative electrode 3, and the separator 4, and the resultant stacked material is spirally wound many times in the longitudinal direction to produce a spirally wound electrode assembly 13.

Next, the spirally wound electrode assembly 13 is placed in a battery casing 1 having an insulating plate 6 preliminarily inserted to the bottom of the casing, and having an inner wall, for example, nickel-placed preliminarily. Further, an insulating plate 6 is provided on the upper surface of the spirally wound electrode assembly 13. Then, for collecting a current for the negative electrode 3, one end of a negative electrode lead 12 comprised of, for example, nickel is fitted to the negative electrode 3, and another end of the lead is welded to the battery casing 1, so that the battery casing 1 is electrically connected to the negative electrode 3 and serves as an outside negative electrode. On the other hand, for collecting a current for the positive electrode 2, one end of a positive electrode lead 11 comprised of, for example, aluminum is fitted to the positive electrode 2, and another end of the lead is electrically connected to a battery cover 7 through a safety valve 8, so that the battery cover 7 is electrically connected to the positive electrode 2 and serves as an outside positive electrode.

Then, an electrolytic solution prepared by dissolving an electrolyte in an organic solvent is charged into the battery casing 1, and then the battery casing 1 is crimped through a gasket 10 coated with asphalt, thus producing a cylindrical lithium-iron disulfide primary battery having the battery cover 7 fixed thereto.

According to the one embodiment of the present invention, the following effects can be obtained.

The lithium-iron disulfide primary battery includes a positive electrode 2 including a cathode composition layer formed on a cathode current collector, a negative electrode 3 including an anode active material comprised of lithium, and an electrolytic solution including an electrolyte dissolved in an organic solvent. The organic solvent includes at least an alkylamide solvent. By this construction of the battery, the elevation of the open circuit voltage of the lithium-iron disulfide primary battery during the storage can be suppressed. Therefore, even after being stored for a long term, the lithium-iron disulfide primary battery can maintain compatibility with 1.5-V class primary batteries and the like.

Further, according to the results of the studies conducted by the present inventor, the organic electrolytic solution having the above-mentioned solvent type/solvent composition can be stably present without freezing or evaporating at least at about −20 to 65° C. Therefore, the lithium-iron disulfide primary battery according to the present embodiment can satisfactorily ensure the discharge characteristics at low temperatures (about 0 to −10° C.), which are considered to correspond to a general environment for the use of the battery, or the safety of the battery during the storage at high temperatures (about 50 to 60° C.).

In addition to the above-mentioned solvents, as examples of solvents widely used as solvents for the organic electrolytic solution, there can be mentioned cyclic carbonic acid esters, such as ethylene carbonate (EC), propylene carbonate (PC), and butylene carbonate (BC), and cyclic carboxylic acid esters, such as γ-butyrolactone (GBL) and γ-valerolactone (GVL), but these solvents are likely to undergo ring-opening polymerization on the surface of metallic lithium or a lithium alloy including lithium and an alloying element, such as aluminum, which constitutes the negative electrode in the battery of the present invention, thus adversely affecting the discharge characteristics. For this reason, rather than these organic solvents, the organic solvents having the above-mentioned solvent type/solvent composition are preferably used.

Further, with respect to the potassium salt, e.g., potassium iodide (KI) or potassium trifluoromethanesulfonate (KCF₃SO₃) added to the electrolytic solution, Japanese Patent Application Publication (kohyo) No. Hei 11-507761 has a description concerning the same effect, but, in the invention described in this patent document, the electrolytic solution has a poor solvent power for the potassium salt. Therefore, the effect of addition of the potassium salt is expected, but only a relatively small amount (0.001 to 0.05 mol/l) of the potassium salt can be added into the electrolytic solution. By contrast, in one embodiment of the present invention, the solvent for the electrolytic solution is comprised mainly of an alkylamide solvent having a large donor number indicating a Lewis acidity and having a large solvent power for the potassium salt, and hence a satisfactory amount of the potassium salt can be dissolved in the electrolytic solution. In other words, a uniform electrolytic solution can be prepared by adding the potassium salt as an additive so as to meet the above-mentioned requirements, thus making it possible to suppress the elevation of the open circuit voltage during the storage of battery.

### EXAMPLES

Hereinbelow, the present invention will be described in more detail with reference to the following Examples, which should not be construed as limiting the scope of the present invention.

Studies on the Composition of Organic Solvent

First, lithium-iron disulfide primary batteries in Examples 1 to 13 using a mixed solvent including N,N-dimethylformamide (DMF) as an alkylamide solvent and 1,2-dimethoxyethane (DME) as a chain ether solvent were prepared. Table 1 shows compositions of the mixed solvents in the lithium-iron disulfide primary batteries in Examples 1 to 13 and Comparative Example 1.

TABLE 1

| | DME | DMF | LiI |
|---|---|---|---|
| | COMPO- | COMPO- | CONCEN- |
| | SITION | SITION | TRATION |
| | (vol %) | (vol %) | (mol/l) |
| COMPARATIVE | 100.0 | 0.0 | 1.0 |
| EXAMPLE 1 | | | |
| EXAMPLE 1 | 99.0 | 1.0 | |
| EXAMPLE 2 | 98.0 | 2.0 | |
| EXAMPLE 3 | 97.0 | 3.0 | |
| EXAMPLE 4 | 96.0 | 4.0 | |
| EXAMPLE 5 | 95.5 | 4.5 | |
| EXAMPLE 6 | 95.0 | 5.0 | |
| EXAMPLE 7 | 94.5 | 5.5 | |
| EXAMPLE 8 | 93.0 | 7.0 | |
| EXAMPLE 9 | 90.0 | 10.0 | |
| EXAMPLE 10 | 80.0 | 20.0 | |
| EXAMPLE 11 | 70.0 | 30.0 | |
| EXAMPLE 12 | 50.0 | 50.0 | |
| EXAMPLE 13 | 0.0 | 100.0 | |

### Example 1

First, 98.0% by weight of iron disulfide as a cathode active material, 1.0% by weight of carbon powder as an electrical conductor, and 1.0% by weight of a binder (dry weight) were mixed together, and satisfactorily dispersed in N-methyl-2-pyrrolidone (NMP) as a solvent to prepare a cathode composition slurry. As the iron disulfide which is a cathode active material, “HG-PPC #250”, manufactured and sold by Dowa Mining Co., Ltd., was used. As the carbon powder, “DENKA BLACK HS-100 (powdery)”, manufactured and sold by Denki Kagaku Kogyo Kabushiki Kaisha, was used, and, as the binder, “BM-500B”, manufactured and sold by ZEON CORPORATION., was used.

Then, the cathode composition slurry was applied to both surfaces of a cathode current collector, and dried at 120° C. for 2 hours to evaporate NMP, followed by compression molding under a constant pressure, to prepare a strip positive electrode 2. As the cathode current collector, a strip aluminum foil having a thickness of 20 μm was used. The weight of the dried cathode composition was 1.75 g, and the positive electrode capacity was about 1,530 mAh.

Then, the thus prepared strip positive electrode 2 and a metallic lithium negative electrode 3 having a thickness of 150 μm were stacked on one another in the order of the positive electrode 2, a separator 4, the negative electrode 3, and a separator 4, and the resultant stacked material was spirally wound many times to produce a spirally wound electrode assembly 13 having an outer diameter of 9 mm.

Next, the thus obtained spirally wound electrode assembly 13 was contained in a nickel-plated battery casing 1 made of iron. Then, insulating plates 5, 6 were disposed respectively on the top and bottom of the spirally wound electrode assembly 13, and a positive electrode lead 11 made of aluminum electrically connected to the cathode current collector was welded to a battery cover 7, and a negative electrode lead 12 made of nickel electrically connected to the anode current collector was welded to the battery casing 1.

Then, 1.0% by volume of N,N-dimethylformamide (DMF) as an alkylamide solvent and 99.0% by volume of 1,2-dimethoxyethane (DME) as a chain ether solvent were mixed with each other. Then, lithium iodide (LiI) was added to the resultant mixed solvent to prepare an electrolytic solution having a molar concentration of 1.0 mol/l. Then, the electrolytic solution prepared was charged into the battery casing 1 containing the spirally wound electrode assembly 13.

Next, the battery casing 1 was crimped through an insulating sealing gasket 10 coated with asphalt to fix a safety valve 8 having a current cut-out mechanism, a PTC element 9, and the battery cover 7 so that air tightness of the battery was kept, thus producing a cylindrical lithium-iron disulfide primary battery having a diameter of about 10 mm and a height of about 44 mm.

### Examples 2 to 13 and Comparative Example 1

Substantially the same procedure as in Example 1 was repeated except that N,N-dimethylformamide (DMF) as an alkylamide solvent and 1,2-dimethoxyethane (DME) as a chain ether solvent were mixed in the composition given by volume shown in Table 1 to obtain lithium-iron disulfide primary batteries in Examples 2 to 13 and Comparative Example 1.

Next, lithium-iron disulfide primary batteries in Examples 14 to 26 using a mixed solvent including N,N-dimethylformamide (DMF) as an alkylamide solvent and 1,3-dioxolane (DOL) as a cyclic ether solvent were prepared. Table 2 shows compositions of the mixed solvents in the lithium-iron disulfide primary batteries in Examples 14 to 26 and Comparative Example 2.

TABLE 2

| | DOL | DMF | LiI |
|---|---|---|---|
| | COMPO- | COMPO- | CONCEN- |
| | SITION | SITION | TRATION |
| | (vol %) | (vol %) | (mol/l) |
| COMPARATIVE | 100.0 | 0.0 | 1.0 |
| EXAMPLE 2 | | | |
| EXAMPLE 14 | 99.0 | 1.0 | |
| EXAMPLE 15 | 98.0 | 2.0 | |
| EXAMPLE 16 | 97.0 | 3.0 | |
| EXAMPLE 17 | 96.0 | 4.0 | |
| EXAMPLE 18 | 95.5 | 4.5 | |
| EXAMPLE 19 | 95.0 | 5.0 | |
| EXAMPLE 20 | 94.5 | 5.5 | |
| EXAMPLE 21 | 93.0 | 7.0 | |
| EXAMPLE 22 | 90.0 | 10.0 | |
| EXAMPLE 23 | 80.0 | 20.0 | |
| EXAMPLE 24 | 70.0 | 30.0 | |
| EXAMPLE 25 | 50.0 | 50.0 | |
| EXAMPLE 26 | 0.0 | 100.0 | |

### Example 14

Substantially the same procedure as in Example 1 was repeated except that, instead of the mixed solvent including 1.0% by volume of N,N-dimethylformamide (DMF) as analkylamide solvent and 99.0% by volume of 1,2-dimethoxyethane (DME) as a chain ether solvent, a mixed solvent including 1.0% by volume of N,N-dimethylformamide (DMF) as an alkylamide solvent and 99.0% by volume of 1,3-dioxolane (DOL) as a cyclic ether solvent was used to obtain a lithium-iron disulfide primary battery.

### Examples 15 to 26 and Comparative Example 2

Substantially the same procedure as in Example 14 was repeated except that N,N-dimethylformamide (DMF) as an alkylamide solvent and 1,3-dioxolane (DOL) as a cyclic ether solvent were mixed in the composition given by volume shown in Table 2 to obtain lithium-iron disulfide primary batteries in Examples 15 to 26 and Comparative Example 2.

Next, lithium-iron disulfide primary batteries in Examples 27 to 39 using a mixed solvent including N,N-dimethylformamide (DMF) as an alkylamide solvent and methyl propionate (MP) as a chain carboxylic acid ester solvent were prepared. Table 3 shows compositions of the mixed solvents in the lithium-iron disulfide primary batteries in Examples 27 to 39 and Comparative Example 3.

TABLE 3

| | MP | DMF | LiI |
|---|---|---|---|
| | COMPO- | COMPO- | CONCEN- |
| | SITION | SITION | TRATION |
| | (vol %) | (vol %) | (mol/l) |
| COMPARATIVE | 100.0 | 0.0 | 1.0 |
| EXAMPLE 3 | | | |
| EXAMPLE 27 | 99.0 | 1.0 | |
| EXAMPLE 28 | 98.0 | 2.0 | |
| EXAMPLE 29 | 97.0 | 3.0 | |
| EXAMPLE 30 | 96.0 | 4.0 | |
| EXAMPLE 31 | 95.5 | 4.5 | |
| EXAMPLE 32 | 95.0 | 5.0 | |
| EXAMPLE 33 | 94.5 | 5.5 | |
| EXAMPLE 34 | 93.0 | 7.0 | |
| EXAMPLE 35 | 90.0 | 10.0 | |
| EXAMPLE 36 | 80.0 | 20.0 | |
| EXAMPLE 37 | 70.0 | 30.0 | |
| EXAMPLE 38 | 50.0 | 50.0 | |
| EXAMPLE 39 | 0.0 | 100.0 | |

### Example 27

Substantially the same procedure as in Example 1 was repeated except that, instead of the mixed solvent including 1.0% by volume of N,N-dimethylformamide (DMF) as an alkylamide solvent and 99.0% by volume of 1,2-dimethoxyethane (DME) as a chain ether solvent, a mixed solvent including 1.0% by volume of N,N-dimethylformamide (DMF) as an alkylamide solvent and 99.0% by volume of methyl propionate (MP) as a chain carboxylic acid ester solvent was used to obtain a lithium-iron disulfide primary battery.

### Examples 28 to 39 and Comparative Example 3

Substantially the same procedure as in Example 27 was repeated except that N,N-dimethylformamide (DMF) as an alkylamide solvent and methyl propionate (MP) as a chain carboxylic acid ester solvent were mixed in the composition given by volume shown in Table 3 to obtain lithium-iron disulfide primary batteries in Examples 28 to 39 and Comparative Example 3.

Next, lithium-iron disulfide primary batteries in Examples 40 to 52 using a mixed solvent including N,N-dimethylformamide (DMF) as an alkyl amide solvent and ethyl methyl carbonate (EMC) as a chain carbonic acid ester solvent were prepared. Table 4 shows compositions of the mixed solvents in the lithium-iron disulfide primary batteries in Examples 40 to 52 and Comparative Example 4.

TABLE 4

| | EMC | DMF | LiI |
|---|---|---|---|
| | COMPO- | COMPO- | CONCEN- |
| | SITION | SITION | TRATION |
| | (vol %) | (vol %) | (mol/l) |
| COMPARATIVE | 100.0 | 0.0 | 1.0 |
| EXAMPLE 4 | | | |
| EXAMPLE 40 | 99.0 | 1.0 | |
| EXAMPLE 41 | 98.0 | 2.0 | |
| EXAMPLE 42 | 97.0 | 3.0 | |
| EXAMPLE 43 | 96.0 | 4.0 | |
| EXAMPLE 44 | 95.5 | 4.5 | |
| EXAMPLE 45 | 95.0 | 5.0 | |
| EXAMPLE 46 | 94.5 | 5.5 | |
| EXAMPLE 47 | 93.0 | 7.0 | |
| EXAMPLE 48 | 90.0 | 10.0 | |
| EXAMPLE 49 | 80.0 | 20.0 | |
| EXAMPLE 50 | 70.0 | 30.0 | |
| EXAMPLE 51 | 50.0 | 50.0 | |
| EXAMPLE 52 | 0.0 | 100.0 | |

### Example 40

Substantially the same procedure as in Example 1 was repeated except that, instead of the mixed solvent including 1.0% by volume of N,N-dimethylformamide (DMF) as analkylamide solvent and 99.0% by volume of 1,2-dimethoxyethane (DME) as a chain ether solvent, a mixed solvent including 1.0% by volume of N,N-dimethylformamide (DMF) as an alkylamide solvent and 99.0% by volume of ethyl methyl carbonate (EMC) as a chain carbonic acid ester solvent was used to obtain a lithium-iron disulfide primary battery.

### Examples 41 to 52 and Comparative Example 4

Substantially the same procedure as in Example 40 was repeated except that N,N-dimethylformamide (DMF) as an alkylamide solvent and ethyl methyl carbonate (EMC) as a chain carbonic acid ester solvent were mixed in the composition given by volume shown in Table 4 to obtain lithium-iron disulfide primary batteries in Examples 41 to 52 and Comparative Example 4.

Next, the thus obtained lithium-iron disulfide primary batteries in Examples 1 to 52 and Comparative Examples 1 to 4 were individually subjected to preliminary discharge at a constant current of 100 mA for 1.5 hour (150 mAh). A lithium-iron disulfide battery immediately after being produced has an open circuit voltage as high as 2 V or more and therefore, in general, as mentioned above, about 10% of the battery capacity is discharged in the process called preliminary discharge to lower the electric potential.

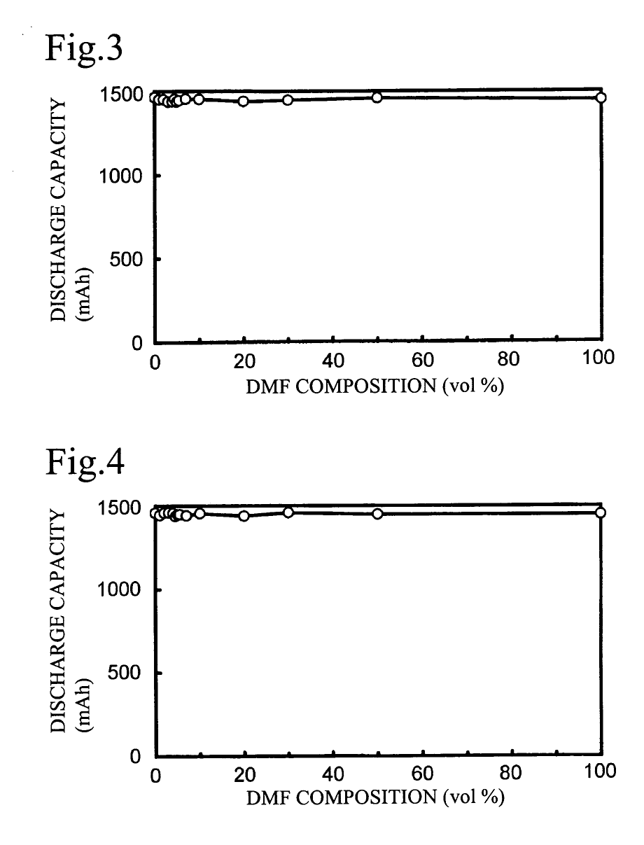

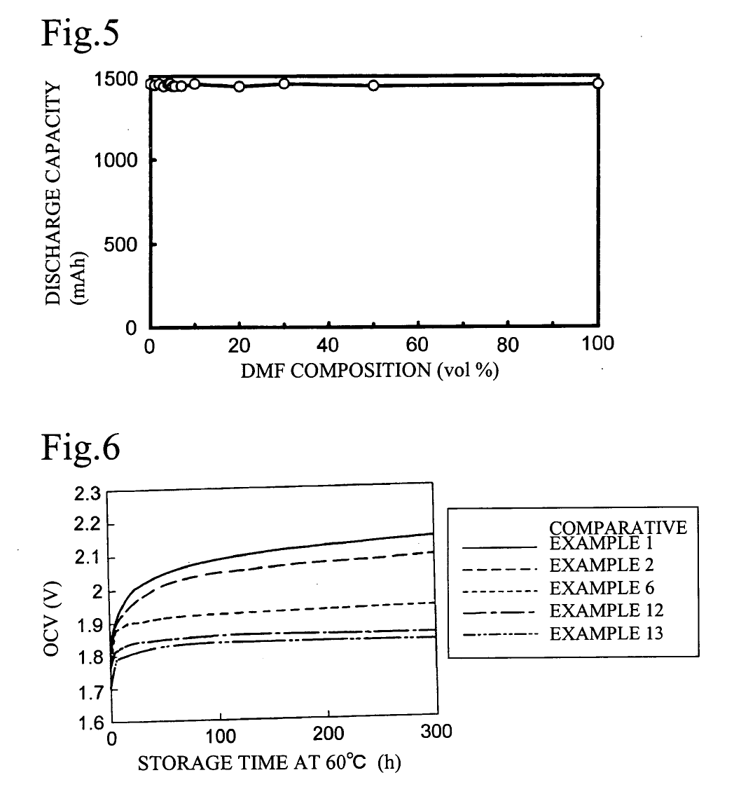

Then, after a lapse of full one day (24 hours), the lithium-iron disulfide primary batteries in the Examples and Comparative Examples were individually subjected to main discharge at a constant current of 100 mA until the battery voltage became 0.5 V to measure a discharge capacity. Table 5 and FIG. 2 show the results of the measurement of the discharge capacity with respect to the lithium-iron disulfide primary batteries in Examples 1 to 13 and Comparative Example 1. Table 6 and FIG. 3 show the results of the measurement of the discharge capacity with respect to the lithium-iron disulfide primary batteries in Examples 14 to 26 and comparative Example 2. Table 7 and FIG. 4 show the results of the measurement of the discharge capacity with respect to the lithium-iron disulfide primary batteries in Examples 27 to 39 and Comparative Example 3. Table 8 and FIG. 5 show the results of the measurement of the discharge capacity with respect to the lithium-iron disulfide primary batteries in Examples 40 to 52 and Comparative Example 4. In FIGS. 2, 3, 4, and 5, the discharge capacity (mAh) is taken as the ordinate, and the N,N-dimethylformamide (DMF) COMPOSITION (% by volume) is taken as the abscissa.

TABLE 5

| | DISCHARGE |
|---|---|
| | CAPACITY (mAh) |
| COMPARATIVE | 1460 |
| EXAMPLE 1 | |
| EXAMPLE 1 | 1437 |
| EXAMPLE 2 | 1448 |
| EXAMPLE 3 | 1448 |
| EXAMPLE 4 | 1442 |
| EXAMPLE 5 | 1442 |
| EXAMPLE 6 | 1448 |
| EXAMPLE 7 | 1448 |
| EXAMPLE 8 | 1442 |
| EXAMPLE 9 | 1448 |
| EXAMPLE 10 | 1448 |
| EXAMPLE 11 | 1454 |
| EXAMPLE 12 | 1442 |
| EXAMPLE 13 | 1448 |

TABLE 6

| | DISCHARGE |
|---|---|
| | CAPACITY (mAh) |
| COMPARATIVE | 1465 |
| EXAMPLE 2 | |
| EXAMPLE 14 | 1452 |
| EXAMPLE 15 | 1452 |
| EXAMPLE 16 | 1439 |
| EXAMPLE 17 | 1441 |
| EXAMPLE 18 | 1453 |
| EXAMPLE 19 | 1439 |
| EXAMPLE 20 | 1445 |
| EXAMPLE 21 | 1455 |
| EXAMPLE 22 | 1452 |
| EXAMPLE 23 | 1440 |
| EXAMPLE 24 | 1446 |
| EXAMPLE 25 | 1458 |
| EXAMPLE 26 | 1448 |

TABLE 7

| | DISCHARGE |
|---|---|
| | CAPACITY (mAh) |
| COMPARATIVE | 1458 |
| EXAMPLE 3 | |
| EXAMPLE 27 | 1444 |
| EXAMPLE 28 | 1458 |
| EXAMPLE 29 | 1459 |
| EXAMPLE 30 | 1456 |
| EXAMPLE 31 | 1439 |
| EXAMPLE 32 | 1449 |
| EXAMPLE 33 | 1449 |
| EXAMPLE 34 | 1442 |
| EXAMPLE 35 | 1455 |
| EXAMPLE 36 | 1438 |
| EXAMPLE 37 | 1458 |
| EXAMPLE 38 | 1448 |
| EXAMPLE 39 | 1448 |

TABLE 8

| | DISCHARGE |
|---|---|
| | CAPACITY (mAh) |
| COMPARATIVE | 1455 |
| EXAMPLE 4 | |
| EXAMPLE 40 | 1446 |
| EXAMPLE 41 | 1452 |
| EXAMPLE 42 | 1439 |
| EXAMPLE 43 | 1454 |
| EXAMPLE 44 | 1455 |
| EXAMPLE 45 | 1439 |
| EXAMPLE 46 | 1438 |
| EXAMPLE 47 | 1440 |
| EXAMPLE 48 | 1452 |
| EXAMPLE 49 | 1437 |
| EXAMPLE 50 | 1455 |
| EXAMPLE 51 | 1441 |
| EXAMPLE 52 | 1448 |

Further, the lithium-iron disulfide primary batteries in Examples 1 to 52 and conventional Examples 1 to 4 which had been subjected to preliminary discharge were stored in an environment at a temperature of 60° C. for 300 hours to measure an open circuit voltage during the storage and after the storage of battery.

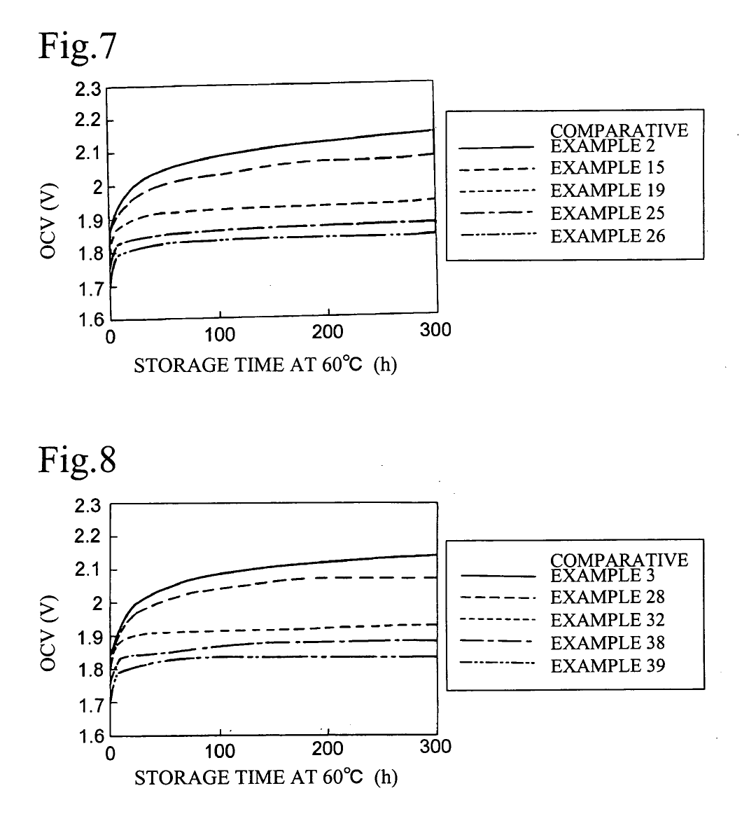

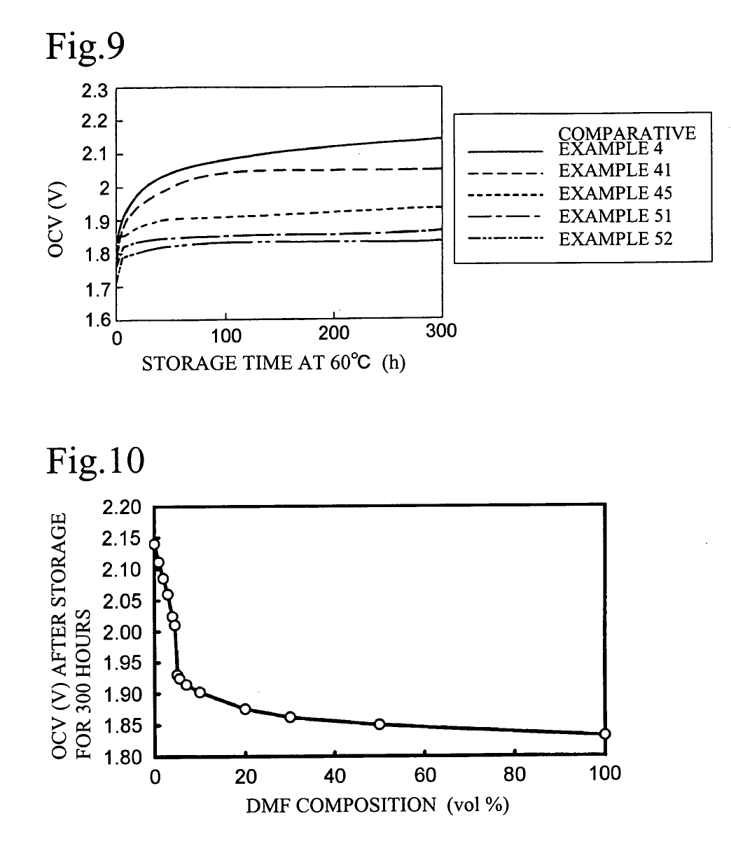

FIGS. 6, 7, 8, and 9 show changes of the open circuit voltage during the storage with respect to the lithium-iron disulfide primary batteries in Examples 1 to 13 and Comparative Example 1, those in Examples 14 to 26 and Comparative Example 2, those in Examples 27 to 39 and Comparative Example 3, and those in Examples 40 to 52 and Comparative Example 4, respectively. In FIGS. 6, 7, 8, and 9, the open circuit voltage (V) is taken as the ordinate, and the time (h) is taken as the abscissa.

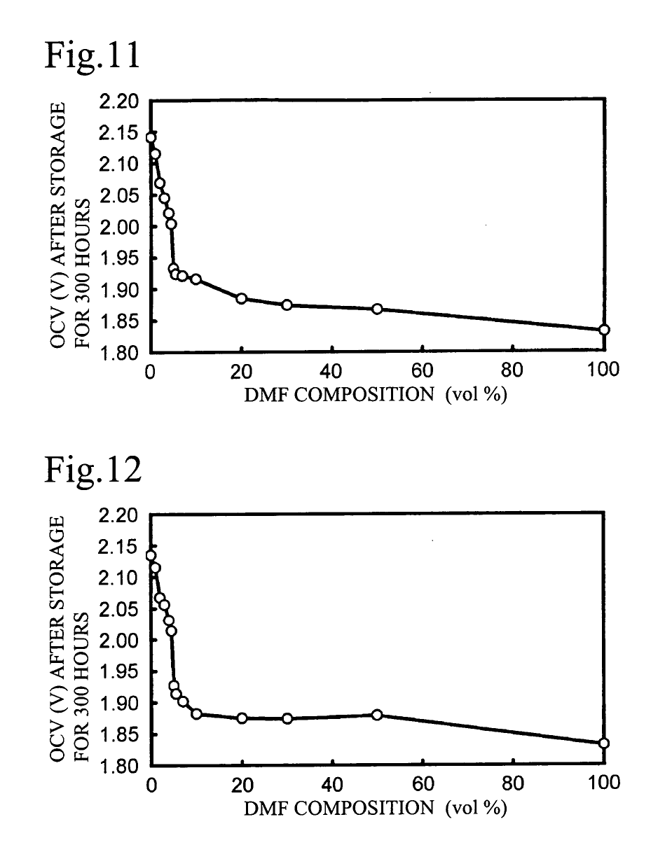

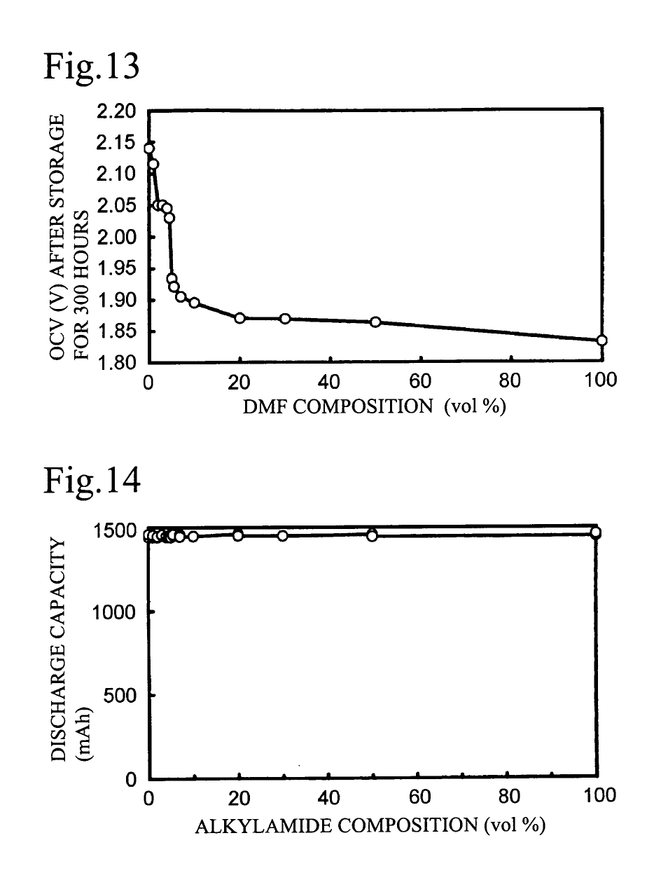

Table 9 and FIG. 10 show the results of the measurement of the open circuit voltage after the storage with respect to the lithium-iron disulfide primary batteries in Examples 1 to 13 and Comparative Example 1. Table 10 and FIG. 11 show the results of the measurement of the open circuit voltage after the storage with respect to the lithium-iron disulfide primary batteries in Examples 14 to 26 and Comparative Example 2. Table 11 and FIG. 12 show the results of the measurement of the open circuit voltage after the storage with respect to the lithium-iron disulfide primary batteries in Examples 27 to 39 and Comparative Example 3. Table 12 and FIG. 13 show the results of the measurement of the open circuit voltage after the storage with respect to the lithium-iron disulfide primary batteries in Examples 40 to 52 and Comparative Example 4. In FIGS. 10, 11, 12, and 13, the open circuit voltage (V) is taken as the ordinate, and the N,N-dimethylformamide (DMF) COMPOSITION (% by volume) is taken as the abscissa.

TABLE 9

| | OCV (V) AFTER STORAGE |
|---|---|
| | FOR 300 HOURS |
| COMPARATIVE | 2.140 |
| EXAMPLE 1 | |
| EXAMPLE 1 | 2.111 |
| EXAMPLE 2 | 2.085 |
| EXAMPLE 3 | 2.060 |
| EXAMPLE 4 | 2.024 |
| EXAMPLE 5 | 2.010 |
| EXAMPLE 6 | 1.930 |
| EXAMPLE 7 | 1.924 |
| EXAMPLE 8 | 1.914 |
| EXAMPLE 9 | 1.902 |
| EXAMPLE 10 | 1.875 |
| EXAMPLE 11 | 1.862 |
| EXAMPLE 12 | 1.850 |
| EXAMPLE 13 | 1.832 |

TABLE 10

| | OCV (V) AFTER STORAGE |
|---|---|
| | FOR 300 HOURS |
| COMPARATIVE | 2.141 |
| EXAMPLE 2 | |
| EXAMPLE 14 | 2.115 |
| EXAMPLE 15 | 2.069 |
| EXAMPLE 16 | 2.045 |
| EXAMPLE 17 | 2.021 |
| EXAMPLE 18 | 2.004 |
| EXAMPLE 19 | 1.933 |
| EXAMPLE 20 | 1.924 |
| EXAMPLE 21 | 1.921 |
| EXAMPLE 22 | 1.916 |
| EXAMPLE 23 | 1.885 |
| EXAMPLE 24 | 1.874 |
| EXAMPLE 25 | 1.867 |
| EXAMPLE 26 | 1.832 |

TABLE 11

| | OCV (V) AFTER STORAGE |
|---|---|
| | FOR 300 HOURS |
| COMPARATIVE | 2.135 |
| EXAMPLE 3 | |
| EXAMPLE 27 | 2.115 |
| EXAMPLE 28 | 2.067 |
| EXAMPLE 29 | 2.056 |
| EXAMPLE 30 | 2.031 |
| EXAMPLE 31 | 2.014 |
| EXAMPLE 32 | 1.927 |
| EXAMPLE 33 | 1.914 |
| EXAMPLE 34 | 1.902 |
| EXAMPLE 35 | 1.882 |
| EXAMPLE 36 | 1.875 |
| EXAMPLE 37 | 1.874 |
| EXAMPLE 38 | 1.897 |
| EXAMPLE 39 | 1.832 |

TABLE 12

| | OCV (V) AFTER STORAGE |
|---|---|
| | FOR 300 HOURS |
| COMPARATIVE | 2.140 |
| EXAMPLE 4 | |
| EXAMPLE 40 | 2.115 |
| EXAMPLE 41 | 2.050 |
| EXAMPLE 42 | 2.050 |
| EXAMPLE 43 | 2.045 |
| EXAMPLE 44 | 2.030 |
| EXAMPLE 45 | 1.934 |
| EXAMPLE 46 | 1.921 |
| EXAMPLE 47 | 1.905 |
| EXAMPLE 48 | 1.895 |
| EXAMPLE 49 | 1.870 |
| EXAMPLE 50 | 1.869 |
| EXAMPLE 51 | 1.863 |
| EXAMPLE 52 | 1.832 |

As can be seen from Tables 5 to 8 and FIGS. 2 to 5, the lithium-iron disulfide primary batteries in Examples 1 to 52 and Comparative Examples 1 to 4 have almost the same discharge capacity. That is, it is found that the discharge capacity of the lithium-iron disulfide primary battery does not vary depending on the content of N,N-dimethylformamide (DMF) in the electrolytic solution.

As can be seen from FIGS. 6 to 9, as the N,N-dimethylformamide (DMF) COMPOSITION is larger, the elevation of the open circuit voltage during the storage of battery in an environment at a temperature of 60° C. is suppressed.

As can be seen from Tables 9 to 12 and FIGS. 10 to 13, in the region of 0 to 5.0% by volume, the open circuit voltage value after the storage of battery in an environment at a temperature of 60° C. for 300 hours is markedly reduced, whereas, in the region of 5.0 to 100.0% by volume, the open circuit voltage value is gradually reduced and suppressed to be 2.0 V or less.

Descriptions of the following results with reference to the drawings are omitted for convenience sake. When organic solvents other than those used in Examples 1 to 52 above were used, tendencies similar to those seen in Examples 1 to 52 above were obtained. Specifically, when a mixed solvent including N,N-dimethylformamide (DMF) and 4-methyl-1,3-dioxolane (4MeDOL), tetrahydrofuran (THF), or 2-methyltetrahydrofuran (2MeTHF), a mixed solvent including N,N-dimethylformamide (DMF), 4-methyl-1,3-dioxolane (4MeDOL), tetrahydrofuran (THF), and 2-methyltetrahydrofuran (2MeTHF), and the like were used, tendencies similar to those seen in Examples 1 to 52 above were obtained. In addition, when a mixed solvent including N,N-dimethylformamide (DMF) and diethyl carbonate (DEC) was used, a tendency similar to those seen in Examples 1 to 52 above was obtained. Further, when a mixed solvent obtained by mixing together N,N-dimethylformamide (DMF), 1,2-dimethoxyethane (DME), 1,3-dioxolane (DOL), methyl propionate (MP), and ethyl methyl carbonate (EMC), and the like were used, tendencies similar to those seen in Examples 1 to 52 above were obtained.

From the above results, it is found that, for suppressing the lowering of the discharge capacity, the content of N,N-dimethylformamide (DMF) in the solvent for the electrolytic solution is preferably in the range of 5.0 to 100% by volume. That is, it is found that the content of the alkylamide solvent in the solvent for the electrolytic solution is preferably in the range of 5.0 to 100% by volume.

Studies on the Composition of Alkylamide Solvent

Next, studies were made on the composition of the alkylamide solvent (DMF/DMA/DEF mixed solvent). Table 13 shows compositions of the alkylamide solvents in the lithium-iron disulfide primary batteries in Examples 53 to 78 and Comparative Examples 5 and 6.

TABLE 13

| | 1 | | | | | 2 | | | | |
|---|---|---|---|---|---|---|---|---|---|---|
| | DME | DOL | MP | EMC | TOTAL OF | DMF | DMA | DEF | TOTAL OF | LiI |
| | COM- | COM- | COM- | COM- | \mathring{1} COM- | COM- | COM- | COM- | \mathring{2} COM- | CONCEN- |
| | POSI- | POSI- | POSI- | POSI- | POSI- | POSI- | POSI- | POSI- | POSI- | CONCEN- |
| | TION | TION | TION | TION | TION | TION | TION | TION | TION | TRATION |
| | (vol %) | (vol %) | (vol %) | (vol %) | (vol %) | (vol %) | (vol %) | (vol %) | (vol %) | (mol/l) |
| COMPARATIVE | 25.0 | 25.0 | 25.0 | 25.0 | 100.0 | 0.0 | 0.0 | 0.0 | 0.0 | 1.0 |
| EXAMPLE 5 | | | | | | | | | | |
| COMPARATIVE | 40.0 | 33.0 | 12.0 | 15.0 | 100.0 | 0.0 | 0.0 | 0.0 | 0.0 | |
| EXAMPLE 6 | | | | | | | | | | |
| EXAMPLE 53 | 23.0 | 24.0 | 23.0 | 29.0 | 99.0 | 0.5 | 0.5 | 0.0 | 1.0 | |
| EXAMPLE 54 | 12.0 | 17.0 | 30.0 | 40.0 | 99.0 | 0.3 | 0.3 | 0.4 | 1.0 | |
| EXAMPLE 55 | 18.0 | 4.0 | 50.0 | 26.0 | 98.0 | 1.0 | 0.5 | 0.5 | 2.0 | |
| EXAMPLE 56 | 29.0 | 26.0 | 18.0 | 25.0 | 98.0 | 0.0 | 1.5 | 0.5 | 2.0 | |
| EXAMPLE 57 | 10.0 | 34.0 | 16.0 | 37.0 | 97.0 | 1.0 | 1.0 | 1.0 | 3.0 | |
| EXAMPLE 58 | 35.0 | 22.0 | 38.0 | 2.0 | 97.0 | 2.0 | 1.0 | 0.0 | 3.0 | |
| EXAMPLE 59 | 20.0 | 10.0 | 31.0 | 35.0 | 96.0 | 1.5 | 1.5 | 1.0 | 4.0 | |
| EXAMPLE 60 | 23.0 | 40.0 | 26.0 | 7.0 | 96.0 | 2.0 | 0.0 | 2.0 | 4.0 | |
| EXAMPLE 61 | 13.0 | 16.0 | 33.0 | 33.5 | 95.5 | 1.5 | 1.5 | 1.5 | 4.5 | |
| EXAMPLE 62 | 38.5 | 16.0 | 26.0 | 15.0 | 95.5 | 3.0 | 1.0 | 0.5 | 4.5 | |
| EXAMPLE 63 | 30.0 | 27.0 | 18.0 | 20.0 | 95.0 | 2.0 | 2.0 | 1.0 | 5.0 | |
| EXAMPLE 64 | 50.0 | 11.0 | 25.0 | 9.0 | 95.0 | 1.5 | 1.5 | 2.0 | 5.0 | |
| EXAMPLE 65 | 32.0 | 35.0 | 10.0 | 17.5 | 94.5 | 2.5 | 1.5 | 1.5 | 5.5 | |
| EXAMPLE 66 | 27.5 | 23.0 | 18.0 | 26.0 | 94.5 | 2.0 | 1.0 | 2.5 | 5.5 | |
| EXAMPLE 67 | 5.0 | 34.0 | 32.0 | 22.0 | 93.0 | 3.0 | 2.0 | 2.0 | 7.0 | |
| EXAMPLE 68 | 19.0 | 19.0 | 21.0 | 34.0 | 93.0 | 4.0 | 1.5 | 1.5 | 7.0 | |
| EXAMPLE 69 | 10.0 | 37.0 | 30.0 | 13.0 | 90.0 | 3.0 | 4.0 | 3.0 | 10.0 | |
| EXAMPLE 70 | 17.0 | 14.0 | 30.0 | 29.0 | 90.0 | 1.0 | 5.0 | 4.0 | 10.0 | |
| EXAMPLE 71 | 23.0 | 28.0 | 15.0 | 14.0 | 80.0 | 7.0 | 7.0 | 6.0 | 20.0 | |
| EXAMPLE 72 | 40.0 | 12.0 | 23.0 | 5.0 | 80.0 | 5.0 | 10.0 | 5.0 | 20.0 | |
| EXAMPLE 73 | 5.0 | 24.0 | 11.0 | 30.0 | 70.0 | 10.0 | 10.0 | 10.0 | 30.0 | |
| EXAMPLE 74 | 28.0 | 19.0 | 15.0 | 8.0 | 70.0 | 5.0 | 20.0 | 5.0 | 30.0 | |
| EXAMPLE 75 | 12.5 | 12.5 | 12.5 | 12.5 | 50.0 | 16.5 | 16.5 | 17.0 | 50.0 | |
| EXAMPLE 76 | 25.0 | 15.0 | 5.0 | 5.0 | 50.0 | 30.0 | 10.0 | 10.0 | 50.0 | |
| EXAMPLE 77 | 0.0 | 0.0 | 0.0 | 0.0 | 0.0 | 34.0 | 33.0 | 33.0 | 100.0 | |
| EXAMPLE 78 | 0.0 | 0.0 | 0.0 | 0.0 | 0.0 | 50.0 | 25.0 | 25.0 | 100.0 | |

### Example 53

Substantially the same procedure as in Example 1 was repeated except that, instead of the mixed solvent including 1.0% by volume of N,N-dimethylformamide (DMF) as an alkylamide solvent and 99.0% by volume of 1,2-dimethoxyethane (DME) as a chain ether solvent, a mixed solvent including 23.0% by volume of 1,2-dimethoxyethane (DME), 24.0% by volume of 1,3-dioxolane (DOL), 23.0% by volume of methyl propionate (MP), 29.0% by volume of ethyl methyl carbonate (EMC), 0.5% by volume of N,N-dimethylformamide (DMF), 0.5% by volume of N,N-dimethylacetamide (DMA), and 0% by volume of N,N-diethylformamide (DEF) was used to obtain a lithium-iron disulfide primary battery.

### Examples 54 to 78 and Comparative Examples 5 and 6

Substantially the same procedure as in Example 53 was repeated except that 1,2-dimethoxyethane (DME), 1,3-dioxolane (DOL), methyl propionate (MP), ethyl methyl carbonate (EMC), N,N-dimethylformamide (DMF), N,N-dimethylacetamide (DMA), and N,N-diethylformamide (DEF) were mixed in the composition given by volume shown in Table 13 to obtain lithium-iron disulfide primary batteries in Examples 54 to 78 and Comparative Examples 5 and 6.

Next, the thus obtained lithium-iron disulfide primary batteries in Examples 53 to 78 and Comparative Examples 5 and 6 were individually subjected to preliminary discharge at a constant current of 100 mA for 1.5 hour (150 mAh). A lithium-iron disulfide battery immediately after being produced has an open circuit voltage as high as 2 V or more and therefore, in general, as mentioned above, about 10% of the battery capacity is discharged in the process called preliminary discharge to lower the electric potential.

Then, after a lapse of full one day (24 hours), the lithium-iron disulfide primary batteries in the Examples and Comparative Examples were individually subjected to main discharge at a constant current of 100 mA until the battery voltage became 0.5 V to measure a discharge capacity. Table 14 and FIG. 14 show the results of the measurement of the discharge capacity with respect to the lithium-iron disulfide primary batteries in Examples 53 to 78 and Comparative Examples 5 and 6. In FIG. 14, the discharge capacity (mAh) is taken as the ordinate, and the alkylamide solvent content (% by volume) is taken as the abscissa.

TABLE 14

| | DISCHARGE |
|---|---|
| | CAPACITY (mAh) |
| COMPARATIVE | 1443 |
| EXAMPLE 5 | |
| COMPARATIVE | 1458 |
| EXAMPLE 6 | |
| EXAMPLE 53 | 1441 |
| EXAMPLE 54 | 1453 |
| EXAMPLE 55 | 1441 |
| EXAMPLE 56 | 1445 |
| EXAMPLE 57 | 1454 |
| EXAMPLE 58 | 1456 |
| EXAMPLE 59 | 1442 |
| EXAMPLE 60 | 1448 |
| EXAMPLE 61 | 1451 |
| EXAMPLE 62 | 1443 |
| EXAMPLE 63 | 1457 |
| EXAMPLE 64 | 1441 |
| EXAMPLE 65 | 1452 |
| EXAMPLE 66 | 1457 |
| EXAMPLE 67 | 1457 |
| EXAMPLE 68 | 1444 |
| EXAMPLE 69 | 1448 |
| EXAMPLE 70 | 1447 |
| EXAMPLE 71 | 1460 |
| EXAMPLE 72 | 1449 |
| EXAMPLE 73 | 1449 |
| EXAMPLE 74 | 1448 |
| EXAMPLE 75 | 1457 |
| EXAMPLE 76 | 1443 |
| EXAMPLE 77 | 1448 |
| EXAMPLE 78 | 1460 |

Further, the lithium-iron disulfide primary batteries in Examples 53 to 78 and conventional Examples 5 and 6 which had been subjected to preliminary discharge were stored in an environment at a temperature of 60° C. for 300 hours to measure an open circuit voltage during the storage and after the storage of battery.

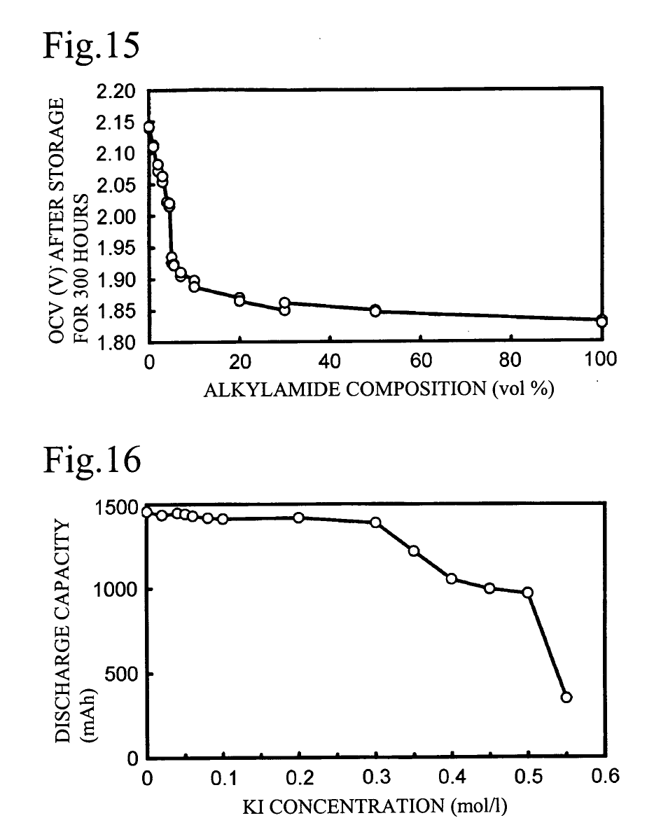

Table 15 and FIG. 15 show the results of the measurement of the open circuit voltage after the storage with respect to the lithium-iron disulfide primary batteries in Examples 53 to 78 and Comparative Examples 5 and 6. In FIG. 15, the open circuit voltage (V) is taken as the ordinate, and the alkylamide solvent COMPOSITION (% by volume) is taken as the abscissa.

TABLE 15

| | OCV (V) AFTER STORAGE |
|---|---|
| | FOR 300 HOURS |
| COMPARATIVE | 2.140 |
| EXAMPLE 5 | |
| COMPARATIVE | 2.142 |
| EXAMPLE 6 | |
| EXAMPLE 53 | 2.113 |
| EXAMPLE 54 | 2.110 |
| EXAMPLE 55 | 2.071 |
| EXAMPLE 56 | 2.082 |
| EXAMPLE 57 | 2.054 |
| EXAMPLE 58 | 2.063 |
| EXAMPLE 59 | 2.022 |
| EXAMPLE 60 | 2.022 |
| EXAMPLE 61 | 2.015 |
| EXAMPLE 62 | 2.020 |
| EXAMPLE 63 | 1.926 |
| EXAMPLE 64 | 1.935 |
| EXAMPLE 65 | 1.924 |
| EXAMPLE 66 | 1.922 |
| EXAMPLE 67 | 1.905 |
| EXAMPLE 68 | 1.911 |
| EXAMPLE 69 | 1.898 |
| EXAMPLE 70 | 1.888 |
| EXAMPLE 71 | 1.870 |
| EXAMPLE 72 | 1.865 |
| EXAMPLE 73 | 1.850 |
| EXAMPLE 74 | 1.862 |
| EXAMPLE 75 | 1.850 |
| EXAMPLE 76 | 1.847 |
| EXAMPLE 77 | 1.832 |
| EXAMPLE 78 | 1.828 |

As can be seen from Table 14 and FIG. 14, the lithium-iron disulfide primary batteries in Examples 53 to 78 and Comparative Examples 5 and 6 have almost the same discharge capacity. That is, it is found that the discharge capacity of the lithium-iron disulfide primary battery does almost not vary depending on the alkylamide solvent COMPOSITION.

As can be seen from Table 15 and FIG. 15, in the region of 0 to 5.0% by volume, the open circuit voltage value after the environmental test is markedly reduced, whereas, in the region of 5.0 to 100.0% by volume, the open circuit voltage value after the environmental test is gradually reduced and suppressed to be 2.0 V or less.

Descriptions of the following results with reference to the drawings are omitted for convenience sake. When organic solvents other than those used in Examples 53 to 78 above were used, tendencies similar to those seen in Examples 53 to 78 above were obtained. Specifically, when an alkylamide solvent including N,N-dimethylformamide (DMF) and N,N-dimethylacetamide (DMA), an alkylamide solvent including N,N-dimethylformamide (DMF) and N,N-diethylformamide (DEF), and a mixed solvent including N,N-dimethylacetamide (DMA) and N,N-diethylformamide (DEF), and the like were used, tendencies similar to those seen in Examples 53 to 78 above were obtained. Further, when the solvent to be mixed into the alkylamide solvent was changed, tendencies similar to those seen in Examples 53 to 78 above were obtained.

From the above results, it is found that, for suppressing the lowering of the discharge capacity, the content of the alkylamide solvent in the solvent for the electrolytic solution is preferably in the range of 5.0 to 100% by volume even when two or more types of alkylamide solvents are contained in the electrolytic solution.

Studies on the Amount of Potassium Salt

Next, studies were made on the amount of a potassium salt added to the electrolytic solution when one type of a potassium salt was added to the electrolytic solution. Table 16 shows the concentration of a potassium salt in the electrolytic solution.

TABLE 16

| | ELECTROLYTIC | | | LiI | KI | KI |
|---|---|---|---|---|---|---|
| | SOLUTION | | | CONCEN- | CONCEN- | CONCENTRATION |
| | COMPOSITION | | | TRATION | TRATION | (mol/l) FOR TOTAL |
| | (vol %) | | | (mol/l) | (mol/l) | AMOUNT OF ※ |
| EXAMPLE 79 | DME: 12.5 | | | 1.0 | 0.00 | 0.00 |
| EXAMPLE 80 | DOL: 12.5 | | | | 0.02 | 0.04 |
| EXAMPLE 81 | MP: 12.5 | | | | 0.04 | 0.08 |
| EXAMPLE 82 | EMC: 12.5 | | | | 0.05 | 0.10 |
| EXAMPLE 83 | DMF: 16.5 | | | | 0.06 | 0.12 |
| EXAMPLE 84 | DMA: 16.5 | {close oversize brace} | ※ | | 0.08 | 0.16 |
| EXAMPLE 85 | DEF: 17.0 | | | | 0.10 | 0.20 |
| EXAMPLE 86 | | | | | 0.20 | 0.40 |
| EXAMPLE 87 | | | | | 0.30 | 0.60 |
| EXAMPLE 88 | | | | | 0.35 | 0.70 |
| EXAMPLE 89 | | | | | 0.40 | 0.80 |
| EXAMPLE 90 | | | | | 0.45 | 0.90 |
| EXAMPLE 91 | | | | | 0.50 | 1.00 |
| EXAMPLE 92 | | | | | 0.55 | 1.10 |

### Example 79

Substantially the same procedure as in Example 1 was repeated except that, instead of the mixed solvent including 1.0% by volume of N,N-dimethylformamide (DMF) as an alkylamide solvent and 99.0% by volume of 1,2-dimethoxyethane (DME) as a chain ether solvent, a mixed solvent including 12.5% by volume of 1,2-dimethoxyethane (DME), 12.5% by volume of 1,3-dioxolane (DOL), 12.5% by volume of methyl propionate (MP), 12.5% by volume of ethyl methyl carbonate (EMC), 16.5% by volume of N,N-dimethylformamide (DMF), 16.5% by volume of N,N-dimethylacetamide (DMA), and 17.0% by volume of N,N-diethylformamide (DEF) was used to obtain a lithium-iron disulfide primary battery.

### Examples 80 to 92

Substantially the same procedure as in Example 79 was repeated except that potassium iodide (KI) as an additive was added to the electrolytic solution so that the molar concentration relative to the organic solvent became values shown in Table 16 to obtain lithium-iron disulfide primary batteries in Examples 80 to 92.

Next, the thus obtained lithium-iron disulfide primary batteries in Examples 79 to 92 were individually subjected to preliminary discharge at a constant current of 100 mA for 1.5 hour (150 mAh). A lithium-iron disulfide battery immediately after being produced has an open circuit voltage as high as 2 V or more and therefore, in general, as mentioned above, about 10% of the battery capacity is discharged in the process called preliminary discharge to lower the electric potential.

Then, after a lapse of full one day (24 hours), the lithium-iron disulfide primary batteries in the Examples were individually subjected to main discharge at a constant current of 100 mA until the battery voltage became 0.5 V to measure a discharge capacity. Table 17 and FIG. 16 show the results of the measurement of the discharge capacity with respect to the lithium-iron disulfide primary batteries in Examples 79 to 92.

TABLE 17

| | DISCHARGE |
|---|---|
| | CAPACITY (mAh) |
| EXAMPLE 79 | 1457 |
| EXAMPLE 80 | 1436 |
| EXAMPLE 81 | 1448 |
| EXAMPLE 82 | 1442 |
| EXAMPLE 83 | 1430 |
| EXAMPLE 84 | 1419 |
| EXAMPLE 85 | 1413 |
| EXAMPLE 86 | 1419 |
| EXAMPLE 87 | 1389 |
| EXAMPLE 88 | 1219 |
| EXAMPLE 89 | 1053 |
| EXAMPLE 90 | 994 |
| EXAMPLE 91 | 969 |
| EXAMPLE 92 | 347 |

Further, the lithium-iron disulfide primary batteries in Examples 79 to 92 which had been subjected to preliminary discharge were stored in an environment at a temperature of 60° C. for 300 hours to measure an open circuit voltage during the storage and after the storage of battery.

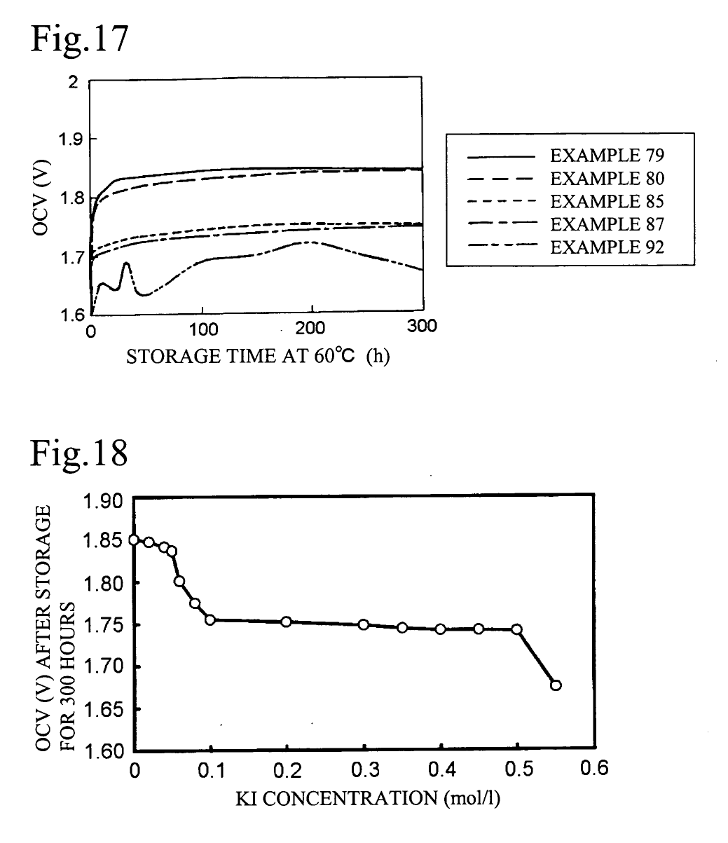

FIG. 17 shows changes of the open circuit voltage during the storage with respect to the lithium-iron disulfide primary batteries in Examples 79 to 92. In FIG. 17, the open circuit voltage (V) is taken as the ordinate, and the time (h) is taken as the abscissa.

Table 18 and FIG. 18 show the results of the measurement of the open circuit voltage after the storage with respect to the lithium-iron disulfide primary batteries in Examples 79 to 92. In FIG. 18, the open circuit voltage (V) is taken as the ordinate, and the potassium salt molar concentration (mol/l) is taken as the abscissa.

TABLE 18

| | OCV (V) AFTER STORAGE |
|---|---|
| | FOR 300 HOURS |
| EXAMPLE 79 | 1.850 |
| EXAMPLE 80 | 1.847 |
| EXAMPLE 81 | 1.841 |
| EXAMPLE 82 | 1.836 |
| EXAMPLE 83 | 1.801 |
| EXAMPLE 84 | 1.775 |
| EXAMPLE 85 | 1.755 |
| EXAMPLE 86 | 1.752 |
| EXAMPLE 87 | 1.748 |
| EXAMPLE 88 | 1.744 |
| EXAMPLE 89 | 1.742 |
| EXAMPLE 90 | 1.742 |
| EXAMPLE 91 | 1.741 |
| EXAMPLE 92 | 1.674 |

As can be seen from Table 17 and FIG. 16, when the KI concentration of the electrolytic solution is up to 0.3 mol/l, the discharge capacity is substantially constant, whereas, when the KI concentration exceeds 0.3 mol/l, the discharge capacity is gradually lowered, and, when the KI concentration exceeds 0.5 mol/l, the discharge capacity is markedly lowered.

Accordingly, it is apparent that, for suppressing the marked lowering of the discharge capacity, the KI concentration relative to the organic solvent is preferably 0.5 mol/l or less. Further, it is apparent that, for obtaining satisfactorily high discharge capacity, the KI concentration relative to the organic solvent is preferably 0.3 mol/l or less. Specifically, it is apparent that, for suppressing the lowering of the electric capacity, the KI concentration relative to the organic solvent is preferably 0.5 mol/l or less, more preferably 0.3 mol/l or less. Further, when the KI concentration relative to the organic solvent is calculated in terms of the KI concentration relative to the alkylamide solvent, as seen in Table 16, it is apparent that the KI concentration relative to the alkylamide solvent is preferably 1.0 mol/l or less, more preferably 0.6 mol/l or less.

The reason for the fact that the discharge capacity is gradually lowered when the KI concentration is more than 0.3 mol/l is presumed that too large a KI concentration of the electrolytic solution is likely to inhibit lithium ion moving which is caused by the discharge. Further, the reason for the fact that the discharge capacity is markedly lowered when the KI concentration is more than 0.5 mol/l is presumed that precipitation of potassium iodide (KI) crystal in the battery causes internal short-circuiting.

As can be seen from Table 18 and FIGS. 17 and 18, with respect to the open circuit voltage during the storage of battery at 60° C. after the preliminary discharge, the effect of suppressing the elevation starts appearing at a point in time when the KI concentration of the electrolytic solution exceeds 0.05 mol/l, and, the larger the KI concentration of the electrolytic solution, the more effectively the elevation of the open circuit voltage is suppressed. However, as seen from FIG. 17, when the KI concentration of the electrolytic solution exceeds 0.5 mol/l, the open circuit voltage during the storage at 60° C. exhibits an irregular behavior. This is a phenomenon that is often observed when the battery suffers internal short-circuiting as seen in the above discharge test, and the reason for this is presumed that excess potassium iodide (KI) undergoes precipitation in the battery to break the separator 4.

Further, as can be seen from FIG. 18, when the KI concentration is up to 0.1 mol/l, the open circuit voltage is markedly lowered, when the KI concentration is from 0.1 to 0.5 mol/l, the open circuit voltage is substantially constant, and, when the KI concentration exceeds 0.5 mol/l, the open circuit voltage is markedly lowered.

It is noted that the results of the preliminary test conducted by the present inventor have confirmed that, with respect to the potassium iodide (KI) dissolved in the electrolytic solution, when the potassium iodide (KI) concentration relative to the alkylamide solvent in the electrolytic solution is at least 1.0 mol/l or less, no precipitation of potassium iodide (KI) occurs. The KI concentration of the electrolytic solution used in Examples 80 to 92 falls in the range of 0.02 to 0.55 mol/l, but, when the KI concentration relative to the organic solvent is calculated in terms of the KI concentration relative to the alkylamide solvent, as seen in Table 16, the KI concentration relative to the alkylamide solvent falls in the range of 0.04 to 1.10 mol/l. Specifically, the example having a KI concentration of more than 1.0 mol/l in this range corresponds to Example 92.

Descriptions of the following results with reference to the drawings are omitted for convenience sake. When potassium salts other than those used in Examples 79 to 92 above were used, tendencies similar to those seen in Examples 79 to 92 above were obtained. Specifically, when potassium fluoride (KF), potassium chloride (KCl), potassium bromide (KBr), or potassium trifluoromethanesulfonate (KCF₃SO₃) was used, similar results were obtained. Further, when organic solvents having compositions different from those in Examples 79 to 92 were used, tendencies similar to those seen in Examples 79 to 92 above were obtained.

Accordingly, taking the results of the preliminary test into consideration, it is apparent that, for suppressing the elevation of the circuit voltage during the storage of battery, the KI concentration of the electrolytic solution is preferably in the range of 0.05 to 0.5 mol/l relative to the organic solvent, and is preferably 1.0 mol/l or less relative to the alkylamide solvent.

From the results of the above studies, it is found that, for suppressing the lowering of the discharge capacity and the circuit voltage, the potassium iodide (KI) concentration relative to the organic solvent is preferably in the range of 0.05 to 0.5 mol/l, more preferably 0.05 to 0.3 mol/l. In addition, it is found that the potassium iodide (KI) concentration relative to the alkylamide solvent is preferably 1.0 mol/l or less, more preferably 0.6 mol/l or less.

Studies on the Amount of Two or More Types of Potassium Salts

Next, studies were made on the amount of potassium salts added to the electrolytic solution when two or more types of potassium salts were added to the electrolytic solution. Table 19 shows the concentration of potassium salts in the electrolytic solution.

[Table 19]

| | ELECTROLYTIC | | | | | | |
|---|---|---|---|---|---|---|---|
| | SOLUTION | | | Lil | KF | KCl | KBr |
| | COMPOSITION | | | CONCENTRATION | CONCENTRATION | CONCENTRATION | CONCENTRATION |
| | (vol %) | | | (mol/l) | (mol/l) | (mol/l) | (mol/l) |
| EXAMPLE 93 | DME: 12.5 | | | 1.0 | 0.00 | 0.00 | 0.00 |
| EXAMPLE 94 | DOL: 12.5 | | | | 0.01 | 0.01 | 0.01 |
| EXAMPLE 95 | MP: 12.5 | | | | 0.01 | 0.01 | 0.01 |
| EXAMPLE 96 | EMC: 12.5 | | | | 0.02 | 0.02 | 0.01 |
| EXAMPLE 97 | DMF: 16.5 | | | | 0.01 | 0.01 | 0.02 |
| EXAMPLE 98 | DMA: 16.5 | {close oversize brace} | ※ | | 0.01 | 0.02 | 0.02 |
| EXAMPLE 99 | DEF: 17.0 | | | | 0.02 | 0.03 | 0.01 |
| EXAMPLE 100 | | | | | 0.03 | 0.04 | 0.05 |
| EXAMPLE 101 | | | | | 0.06 | 0.06 | 0.06 |
| EXAMPLE 102 | | | | | 0.08 | 0.10 | 0.05 |
| EXAMPLE 103 | | | | | 0.10 | 0.05 | 0.15 |
| EXAMPLE 104 | | | | | 0.05 | 0.05 | 0.05 |
| EXAMPLE 105 | | | | | 0.10 | 0.10 | 0.10 |
| EXAMPLE 106 | | | | | 0.15 | 0.10 | 0.15 |

| | KI | KCF₃S0₃ | POTASSIUM SALT | KI CONCENTRATION |
|---|---|---|---|---|
| | CONCENTRATION | CONCENTRATION | CONCENTRATION | (mol/l) FOR TOTAL |
| | (mol/l) | (mol/l) | (mol/l) | AMOUNT OF ※ |
| EXAMPLE 93 | 0.00 | 0.00 | 0.00 | 0.00 |
| EXAMPLE 94 | 0.00 | 0.01 | 0.02 | 0.04 |
| EXAMPLE 95 | 0.01 | 0.01 | 0.04 | 0.08 |
| EXAMPLE 96 | 0.01 | 0.01 | 0.05 | 0.10 |
| EXAMPLE 97 | 0.02 | 0.01 | 0.06 | 0.12 |
| EXAMPLE 98 | 0.02 | 0.02 | 0.08 | 0.16 |
| EXAMPLE 99 | 0.03 | 0.02 | 0.10 | 0.20 |
| EXAMPLE 100 | 0.04 | 0.05 | 0.20 | 0.40 |
| EXAMPLE 101 | 0.06 | 0.06 | 0.30 | 0.60 |
| EXAMPLE 102 | 0.08 | 0.05 | 0.35 | 0.70 |
| EXAMPLE 103 | 0.05 | 0.05 | 0.40 | 0.80 |
| EXAMPLE 104 | 0.25 | 0.05 | 0.45 | 0.90 |
| EXAMPLE 105 | 0.10 | 0.10 | 0.50 | 1.00 |
| EXAMPLE 106 | 0.05 | 0.10 | 0.55 | 1.10 |

### Example 93

Substantially the same procedure as in Example 1 was repeated except that, instead of the mixed solvent including 1.0% by volume of N,N-dimethylformamide (DMF) as analkylamide solvent and 99.0% by volume of 1,2-dimethoxyethane (DME) as a chain ether solvent, a mixed solvent including 12.5% by weight of 1,2-dimethoxyethane (DME), 12.5% by weight of 1,3-dioxolane (DOL), 12.5% by weight of methyl propionate (MP), 12.5% by weight of ethyl methyl carbonate (EMC), 16.5% by weight of N,N-dimethylformamide (DMF), 16.5% by weight of N,N-dimethylacetamide (DMA), and 17.0% by weight of N,N-diethylformamide (DEF) was used to obtain a lithium-iron disulfide primary battery.

### Examples 94 to 106

Substantially the same procedure as in Example 93 was repeated except that potassium fluoride (KF), potassium chloride (KCl), potassium bromide (KBr), potassium iodide (KI), and potassium trifluoromethanesulfonate (KCF₃SO₃) as an additive was added to the electrolytic solution so that the molar concentration relative to the organic solvent became values shown in Table 19 to obtain lithium-iron disulfide primary batteries in Examples 94 to 106.

Next, the thus obtained lithium-iron disulfide primary batteries in Examples 93 to 106 were individually subjected to preliminary discharge at a constant current of 100 mA for 1.5 hour (150 mAh). A lithium-iron disulfide battery immediately after being produced has an open circuit voltage as high as 2 V or more and therefore, in general, as mentioned above, about 10% of the battery capacity is discharged in the process called preliminary discharge to lower the electric potential.

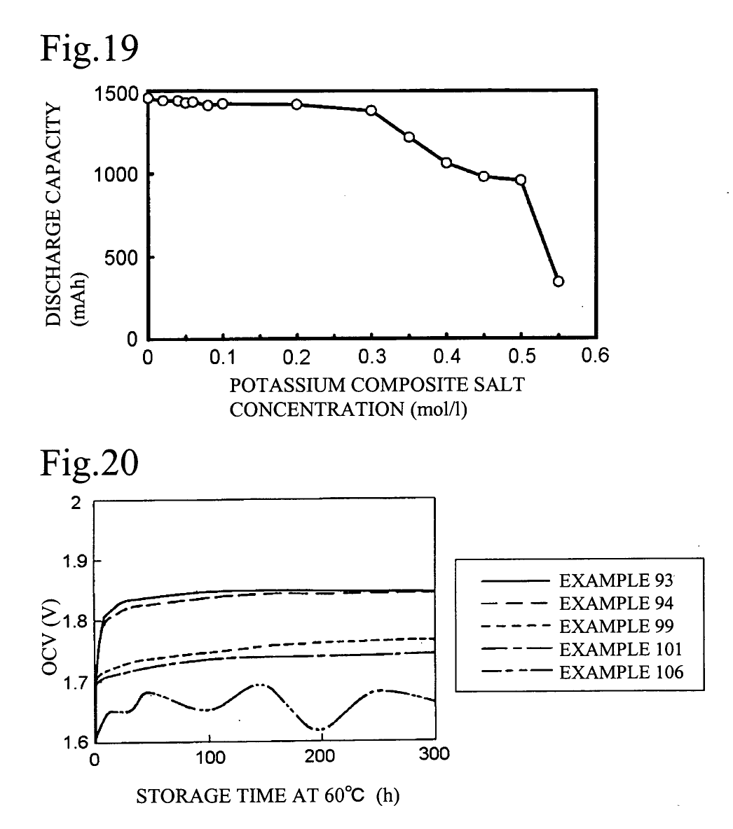

Then, after a lapse of full one day (24 hours), the lithium-iron disulfide primary batteries in the Examples were individually subjected to main discharge at a constant current of 100 mA until the battery voltage became 0.5 V to measure a discharge capacity. Table 20 and FIG. 19 show the results of the measurement of the discharge capacity with respect to the lithium-iron disulfide primary batteries in Examples 93 to 106. In FIG. 19, the discharge capacity (mAh) is taken as the ordinate, and the potassium composite salt concentration (mol/l) is taken as the abscissa.

TABLE 20

| | DISCHARGE |
|---|---|
| | CAPACITY (mAh) |
| EXAMPLE 93 | 1457 |
| EXAMPLE 94 | 1441 |
| EXAMPLE 95 | 1440 |
| EXAMPLE 96 | 1427 |
| EXAMPLE 97 | 1433 |
| EXAMPLE 98 | 1412 |
| EXAMPLE 99 | 1422 |
| EXAMPLE 100 | 1417 |
| EXAMPLE 101 | 1378 |
| EXAMPLE 102 | 1215 |
| EXAMPLE 103 | 1060 |
| EXAMPLE 104 | 977 |
| EXAMPLE 105 | 956 |
| EXAMPLE 106 | 340 |

Further, the lithium-iron disulfide primary batteries in Examples 93 to 106 which had been subjected to preliminary discharge were stored in an environment at a temperature of 60° C. for 300 hours to measure an open circuit voltage during the storage and after the storage of battery.

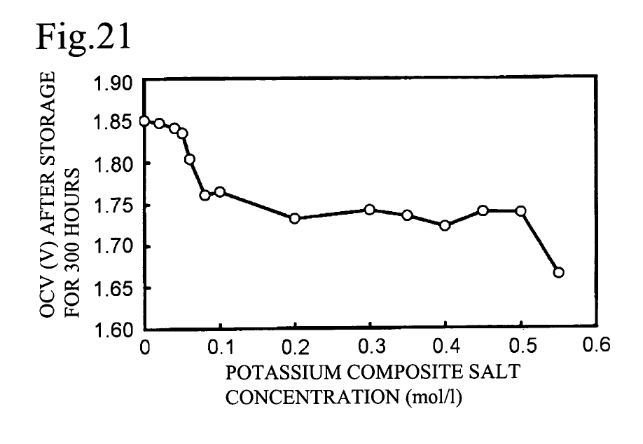

FIG. 20 shows changes of the open circuit voltage during the storage with respect to the lithium-iron disulfide primary batteries in Examples 93 to 106. In FIG. 20, the open circuit voltage (V) is taken as the ordinate, and the time (h) is taken as the abscissa.

Table 21 and FIG. 21 show the results of the measurement of the open circuit voltage after the storage with respect to the lithium-iron disulfide primary batteries in Examples 93 to 106. In FIG. 21, the open circuit voltage (V) is taken as the ordinate, and the potassium composite salt concentration (mol/l) is taken as the abscissa.

TABLE 21

| | OCV (V) AFTER STORAGE |
|---|---|
| | FOR 300 HOURS |
| EXAMPLE 93 | 1.850 |
| EXAMPLE 94 | 1.847 |
| EXAMPLE 95 | 1.841 |
| EXAMPLE 96 | 1.835 |
| EXAMPLE 97 | 1.804 |
| EXAMPLE 98 | 1.761 |
| EXAMPLE 99 | 1.765 |
| EXAMPLE 100 | 1.732 |
| EXAMPLE 101 | 1.742 |
| EXAMPLE 102 | 1.735 |
| EXAMPLE 103 | 1.722 |
| EXAMPLE 104 | 1.740 |
| EXAMPLE 105 | 1.739 |
| EXAMPLE 106 | 1.664 |

As can be seen from Table 20 and FIG. 19, the discharge capacity has a tendency similar to those seen in Examples 79 to 92. Specifically, it is apparent that, when the potassium composite salt concentration of the electrolytic solution is up to 0.3 mol/l, the discharge capacity is substantially constant, whereas, when the concentration exceeds 0.3 mol/l, the discharge capacity is gradually lowered, and, when the concentration exceeds 0.5 mol/l, the discharge capacity is markedly lowered.

Accordingly, it is apparent that, for suppressing the marked lowering of the discharge capacity, the KI concentration relative to the organic solvent is preferably 0.5 mol/l or less. Further, it is apparent that, for obtaining satisfactorily high discharge capacity, the KI concentration relative to the organic solvent is preferably 0.3 mol/l or less. Specifically, it is apparent that, for suppressing the lowering of the electric capacity, the KI concentration relative to the organic solvent is preferably 0.5 mol/l or less, more preferably 0.3 mol/l or less. Further, when the KI concentration relative to the organic solvent is calculated in terms of the KI concentration relative to the alkylamide solvent, as seen in Table 19, it is apparent that the KI concentration relative to the alkylamide solvent is preferably 1.0 mol/l or less, more preferably 0.6 mol/l or less.

The reason for the fact that the discharge capacity is gradually lowered when the KI concentration is more than 0.3 mol/l is presumed that too large a KI concentration of the electrolytic solution is likely to inhibit lithium ion moving which is caused by the discharge. Further, the reason for the fact that the discharge capacity is markedly lowered when the KI concentration is more than 0.5 mol/l is presumed that precipitation of potassium iodide (KI) crystal in the battery causes internal short-circuiting.

As can be seen from Table 21 and FIGS. 20 and 21, the change of the open circuit voltage during the storage of battery at 60° C. after the preliminary discharge has a tendency similar to those seen in Examples 79 to 92. Specifically, the effect of suppressing the elevation of the open circuit voltage starts appearing at a point in time when the potassium composite salt concentration of the electrolytic solution exceeds 0.05 mol/l, and, the larger the potassium composite salt concentration of the electrolytic solution, the more effectively the elevation of the open circuit voltage is suppressed, and, when the potassium composite salt concentration of the electrolytic solution exceeds 0.5 mol/l, the open circuit voltage during the storage at 60° C. exhibits an irregular behavior. The potassium composite salt concentration of the electrolytic solution used in Examples 93 to 106 falls in the range of 0.02 to 0.55 mol/l, but, when the potassium composite salt concentration relative to the organic solvent is calculated in terms of the potassium composite salt concentration relative to the alkylamide solvent, as seen in Table 19, the potassium composite salt concentration relative to the alkylamide solvent falls in the range of 0.04 to 1.1 mol/l. Specifically, the example having a potassium composite salt concentration of more than 1 mol/l in this range corresponds to Example 106.

Further, as can be seen from FIG. 21, when the potassium composite salt concentration is up to 0.1 mol/l, the open circuit voltage is markedly lowered, when the concentration is from 0.1 to 0.5 mol/l, the open circuit voltage is substantially constant, and, when the concentration exceeds 0.5 mol/l, the open circuit voltage is markedly lowered.

Accordingly, it is apparent that, for suppressing the elevation of the circuit voltage during the storage of battery, the composite potassium salt concentration of the electrolytic solution is preferably in the range of 0.05 to 0.5 mol/l relative to the organic solvent, and is preferably 1.0 mol/l or less relative to the alkylamide solvent.

Descriptions of the following results with reference to the drawings are omitted for convenience sake. When potassium composite salts other than those used in Examples 93 to 106 above were used, tendencies similar to those seen in Examples 93 to 106 above were obtained.

From the results of the above studies, it is found that, for suppressing the lowering of the discharge capacity and the open circuit voltage, the composite potassium salt concentration relative to the organic solvent is preferably in the range of 0.05 to 0.5 mol/l, more preferably 0.05 to 0.3 mol/l. In addition, it is found that the composite potassium salt concentration relative to the alkylamide solvent is preferably in the range of 1.0 mol/l or less, more preferably 0.6 mol/l or less.

Hereinabove, one embodiment of the present invention has been described in detail, but the present invention is not limited to the above embodiment, and can be variously modified or changed based on the technical concept of the present invention.

For example, the numbers and values used in the above embodiment are merely examples, and numbers and values different from them may be used if necessary.

Further, in the above embodiment, an example in which the present invention is applied to a cylindrical lithium-iron disulfide primary battery is shown, but the present invention is not limited to the battery of this form. For example, the present invention can be applied to lithium-iron disulfide primary batteries having other forms, such as a flat form (coin-like form).

1. A lithium-iron disulfide primary battery comprising:
a positive electrode including iron disulfide as a cathode active material;
a negative electrode including lithium as an anode active material; and
an electrolytic solution including an electrolytic solution dissolved in an organic solvent,
wherein the organic solvent includes an alkylamide solvent represented by the following formula (1): 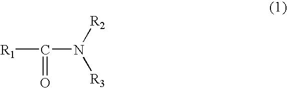
wherein each of R₁ to R₃ represents a hydrogen group or a linear alkyl group.

2. The lithium-iron disulfide primary battery according to claim 1, wherein the alkylamide solvent includes at least one solvent selected from a group consisting of N,N-dimethylformamide (DMF), N,N-dimethylacetamide (DMA), and N,N-diethylformamide (DEF).

3. The lithium-iron disulfide primary battery according to claim 1, wherein a content of the alkylamide solvent in the organic solvent is 5 to 100% by volume.

4. The lithium-iron disulfide primary battery according to claim 1, wherein the organic solvent includes the alkylamide solvent and a chain ether solvent.

5. The lithium-iron disulfide primary battery according to claim 4, wherein the chain ether solvent is 1,2-dimethoxyethane (DME).

6. The lithium-iron disulfide primary battery according to claim 4, wherein a content of the chain ether solvent in the organic solvent is 95% by volume or less.

7. The lithium-iron disulfide primary battery according to claim 1, wherein the organic solvent includes the alkylamide solvent and a cyclic ether solvent.

8. The lithium-iron disulfide primary battery according to claim 7, wherein the cyclic ether solvent includes at least one solvent selected from a group consisting of 1,3-dioxolane (DOL), 4-methyl-1,3-dioxolane (4MeDOL), tetrahydrofuran (THF), and 2-methyltetrahydrofuran (2MeTHF).

9. The lithium-iron disulfide primary battery according to claim 7, wherein a content of the cyclic ether solvent in the organic solvent is 95% by volume or less.

10. The lithium-iron disulfide primary battery according to claim 1, wherein the organic solvent includes the alkylamide solvent and a chain carboxylic acid ester solvent.

11. The lithium-iron disulfide primary battery according to claim 10, wherein the chain carboxylic acid ester solvent is methyl propionate (MP).

12. The lithium-iron disulfide primary battery according to claim 10, wherein a content of the chain carboxylic acid ester solvent in the organic solvent is 95% by volume or less.

13. The lithium-iron disulfide primary battery according to claim 1, wherein the organic solvent includes the alkylamide solvent and a chain carbonic acid ester solvent.

14. The lithium-iron disulfide primary battery according to claim 13, wherein the chain carbonic acid ester solvent includes at least one solvent selected from a group consisting of ethyl methyl carbonate (EMC) and diethyl carbonate (DEC).

15. The lithium-iron disulfide primary battery according to claim 13, wherein a content of the chain carbonic acid ester solvent in the organic solvent is 95% by volume or less.

16. The lithium-iron disulfide primary battery according to claim 1, wherein the organic solvent includes the alkylamide solvent and a mixed solvent of at least two solvents selected from a group consisting of a chain ether solvent, a cyclic ether solvent, a chain carboxylic acid ester solvent, and a chain carbonic acid ester solvent.

17. The lithium-iron disulfide primary battery according to claim 16, wherein a content of the mixed solvent in the organic solvent is 95% by volume or less.

18. The lithium-iron disulfide primary battery according to claim 1, wherein a potassium salt is added to the electrolytic solution.

19. The lithium-iron disulfide primary battery according to claim 18, wherein the potassium salt includes at least one member selected from a group consisting of potassium fluoride (KF), potassium chloride (KCl), potassium bromide (KBr), potassium iodide (KI), and potassium trifluoromethanesulfonate (KCF₃SO₃).

20. The lithium-iron disulfide primary battery according to claim 18, wherein the potassium salt concentration relative to the organic solvent is 0.05 to 0.5 mol/l.

21. The lithium-iron disulfide primary battery according to claim 18, wherein the potassium salt concentration relative to the alkylamide solvent is 1.0 mol/l or less.
